(19) United States
(12) Patent Application Publication
(10) Pub. No.: US 2017/0090814 A1
(43) Pub. Date: Mar. 30, 2017

(54) EFFICIENT STORAGE AND RETRIEVAL FOR WEARABLE-DEVICE DATA

(71) Applicant: INTEL CORPORATION, Santa Clara, CA (US)

(72) Inventors: Fai Yeung, San Jose, CA (US); Fu Zhou, San Jose, CA (US); Nicholas Khosravy, Palo Alto, CA (US)

(73) Assignee: INTEL CORPORATION, Santa Clara, CA (US)

(21) Appl. No.: 14/866,711

(22) Filed: Sep. 25, 2015

(51) Int. Cl. G06F 3/06; G06F 17/30

(52) U.S. Cl. CPC G06F 3/0638; G06F 17/3033; G06F 3/0604; G06F 3/0629; G06F 3/0673

(57) ABSTRACT

Technology described herein provides methods whereby a two-level indexing/hashing structure is used to efficiently coordinate storage of sensor measurements between local digital memory (e.g., at a mobile device) and remote digital memory (e.g., at a cloud storage system). The first level of the two-level indexing/hashing structure may be include an array of first-level nodes that are sorted according to priority values. The priority values may be determined based on user data-querying activity. The second level of the two-level indexing/hashing structure may include second-level hash tables wherein buckets are associated with memory blocks of a predefined size. Sensor measurements that were taken during a specific time period may be stored near each other in memory and may be downloaded for local storage if user activity suggests that the user frequently has interest in data from that time period.

### BACKGROUND

Wearable devices, such as activity trackers, are becoming increasingly popular. These wearable devices typically include sensors configured to measure quantities from which inferences about a wearer's physical condition and physical activity levels may be made. Some examples of sensors that may be used in wearable devices include accelerometers, heart rate monitors (e.g., optical heart rate monitors), thermometers, global positioning system (GPS) locators, bioimpedance sensors, galvanic skin response sensors, ultraviolet (UV) sensors, and optical sensors (e.g., that use light-emitting diodes (LEDs)) that measure blood oxygenation or antioxidant levels.

It is convenient for these wearable devices to be small so that they can be worn throughout a wide range of activities without unduly impeding the wearer's mobility or comfort. Hence, these wearable devices are often small enough to be worn in a sleeve for the leg, an armband, a chest strap, a belt, a shoe, a clip-on assembly, or a wristband.

When a wearable device is worn throughout a wearer's daily activities, sensors of the wearable device can collect desired measurements at a desired rate. The measurements taken during a specific time period may be used to illustrate trends over time. The measurements, for example, may be suitable display in a scatterplot (e.g., of the quantity measured plotted against time). Methods such as regression and interpolation may also be applied to the measurements in order to estimate rates of change and trends over time. Various types of analysis may be applied to the measurements in order to estimate desired quantities that may not be immediately measurable using the sensors (e.g., calories burned).

### BRIEF DESCRIPTION OF THE DRAWINGS

Features and advantages of the disclosure will be apparent from the detailed description which follows, taken in conjunction with the accompanying drawings, which together illustrate, by way of example, features of the disclosure; and, wherein:

FIG. 1 illustrates an example of a first level (L1) list of an indexing/hashing structure in accordance with an example;

FIG. 2 illustrates a detailed example of a second-level (L2) list in accordance with an example;

FIGS. 3a-b illustrate an example of how an indexing/hashing structure may be expanded in accordance with an example;

FIGS. 4a-e illustrate an exemplary manner in which an order of L1 nodes in an L1 list may be updated in accordance with an example;

FIGS. 5a-c illustrate states of a hybrid indexing/hashing structure for coordinating data storage between local digital memory and remote digital memory in accordance with an example;

FIG. 6 illustrates functionality for storing data measurements for efficient retrieval in accordance with an example;

FIG. 7 illustrates functionality for retrieving a data measurement from digital memory in accordance with an example;

FIG. 8 illustrates functionality for coordinating storage of data measurements between local digital memory and a remote data store in accordance with an example; and

FIG. 9 provides an example illustration of a wireless device in accordance with an example.

Reference will now be made to the exemplary embodiments illustrated and specific language will be used herein to describe the same. It will nevertheless be understood that no limitation of the disclosure scope is thereby intended.

### DESCRIPTION OF EMBODIMENTS

Before some embodiments are disclosed and described, it is to be understood that the claimed subject matter is not limited to the particular structures, process operations, or materials disclosed herein, but is extended to equivalents thereof as would be recognized by those ordinarily skilled in the relevant arts. It should also be understood that terminology employed herein is used for the purpose of describing particular examples only and is not intended to be limiting. The same reference numerals in different drawings represent the same element. Numbers provided in flow charts and processes are provided for clarity in illustrating operations and do not necessarily indicate a particular order or sequence.

An initial overview of technology embodiments is provided below and then specific technology embodiments are described in further detail later. This initial summary is intended to aid readers in understanding the technology more quickly, but is not intended to identify key features or essential features of the technology nor is it intended to limit the scope of the claimed subject matter.

A large number of measurements may be taken by the sensors of a wearable device over the course of several hours, days, or months, especially if the rate at which measurements are taken is relatively high. The wearable device's small size, however, may provide limited physical space for physical memory on which the measurements may be stored. Consequently, a wearable device may be configured to cache a small amount of measurement data and transfer other measurement data to another device that has more available physical memory. For example, a wearable device may transfer measurement data to another device, such as a user equipment (UE) (e.g., a mobile cellular phone), a computer (e.g., a laptop or a desktop), or a remote data store (e.g., a cloud service for data storage). The measurement data may be transferred wirelessly (e.g., using Bluetooth, WiFi, or 3GPP technology) or via a wired connection (e.g., using a universal serial port (USB) cable or an auxiliary input cable). In some cases, sensors that take measurements of interest may be part of a UE that is not wearable device. In such cases, the transfer of measurement data from sensors to physical memory of the UE may occur through circuitry of the UE itself. It should be noted that wearable devices and UEs are not mutually exclusive, but rather, a device may be both a wearable device and a UE.

In some examples consistent with the present disclosure, a UE and a sensor may be devices that are considered to be part of a system for storing or retrieving measurement data. In such systems, the sensor may serve as the device within the system that takes measurements of a quantity of interest and conveys the measurements to the UE. In one example, the UE may have an integrated sensor therein and in other examples the sensor device may be a separate and independent device from the UE. In examples where the sensor is separate from the UE, the measurements taken by the sensor may be conveyed wirelessly or through a wired connection (e.g., an auxiliary cable). The UE, in turn, may serve as a device within the system that includes one or more processors (e.g., application processors or baseband processors) that are configured to apply methods described herein in order to determine where and how to store the measurements in order to facilitate efficient storage and retrieval. In a further embodiment, a system may further include a cloud or other remote data store that can communicate with the UE. In one embodiment, the system can include a UE with an integrates sensor and a remote data store that can communicate with the UE. In another embodiment, the system can include a sensor that is capable of communicating with a separate UE, and a remote data store that is capable of communicating with the UE.

While a UE such as a smart phone may store some measurement data, UEs are typically also relatively small and therefore have relatively limited digital storage space. Furthermore, in the case of a smartphone, the UE may be used for many other purposes (e.g., making telephone calls, surfing the internet, streaming media, playing video games, etc.) that require use of the UE's limited storage space. As a result, it may be prudent to limit the amount of the UEs storage space that is designated for storing measurement data from sensors in order to ensure that the UE has sufficient available storage space for other purposes. UEs that store measurement data from sensors (e.g., wearable sensors) may therefore be configured to transfer measurement data via a network connection to a cloud data storage system wherein digital data may be stored across one or more servers.

There are a number of simple approaches addressing how data storage for sensor measurement data is coordinated or synchronized between a UE and a cloud storage system. One approach is to use a basic last-in-first-out (LIFO) scheme (e.g., a stack) wherein measurement data is uploaded at defined time intervals to the cloud storage system in descending order according to measurement timestamps. Another approach is to use a first-in-first-out (FIFO) scheme (e.g., a queue) wherein measurement data is uploaded at defined time intervals to the cloud storage system in ascending order according to measurement timestamps. Measurement data may even be uploaded continuously through streaming so that little or no measurement data is stored locally at the UE (though this may lead to unnecessary use of battery power and bandwidth resources). A single interface may be provided whereby a user can query the measurement data that is stored both locally and remotely. Alternatively, separate interfaces may be used for local data retrieval from the UE's digital memory and for remote data retrieval from the cloud storage system, respectively.

These approaches for coordinating the storage of measurement data between a UE and a cloud storage system have some drawbacks, however. For example, a user may wish to retrieve measurement data from storage for display and inspection on the UE. The user may request that measurement data from a certain day, for example, be displayed in a scatterplot so that the user can see activity patterns for that day. If the measurement data for that day is stored on the UE, the measurement data may be retrieved relatively quickly. However, if the measurement data for that day has been transferred to a cloud storage system and removed from local memory, it may take an inconvenient amount of time to download the measurement data from the cloud storage system to the UE. In areas where cellular or WiFi coverage is unavailable, the user may be unable to download the measurement data until the UE is moved to a location where coverage is available. Furthermore, if separate interfaces are used to retrieve local data and remote data, the user may be obliged to navigate through both interfaces to download desired portions of the desired measurement data.

In order to promote a good quality of experience (QoE) for users of wearable devices and UEs that gather measurement data from sensors, at least some of the measurement data can be stored locally at the UE. However, in the approaches described above, measurement data is selected for local storage based on recentness, based on the type of data structure (e.g., queue or stack) used to cache the data locally, and based on the time intervals at which data is uploaded to the cloud storage system. Even if a user's querying behavior suggests that the user might be more likely to retrieve measurements that were made in a different time frames, the approaches described above provide no solution whereby a UE may preemptively identify and download measurement data from the different time frames. Hence, unless the user happens to conveniently request measurement data from the exact time frame whose measurements are locally stored, the user may have to wait for longer periods of time to access desired measurement data.

For example, suppose a user is a runner who is trying to identify an optimal rate at which to increase a distance for daily runs without causing an overuse injury (e.g., shin splints). The runner wears an activity tracker with various sensors on a daily basis and the activity tracker sends measurement data to the user's smartphone. The smartphone stores the most recent data locally in a FIFO scheme and periodically uploads the rest of the measurement data to a cloud storage system via a wireless cellular network connection.

In this example, also suppose that the user has recently begun to feel pain from an overuse injury—presumably because recent rates of increase in the daily running distance have been too high. Since the user's previous training regimen from about six months prior did not seem to cause any overuse injuries, the user wishes to retrieve measurement data that was gathered during the previous training regimen in order to determine how rates of increase in running distances during the previous training regimen compare to the rates of the user's current training regimen. The user queries the measurement data from six months prior multiple times over the course of a week while trying to ascertain rates of increase in running distance under the prior training regimen. In the meantime, the user takes a week off from running in order to let the overuse injury heal.

In this scenario, the user has little interest in the most recent measurement data from the week in which the user has been recovering. The user also has great interest in the measurement data from six months ago, as indicated by the user's querying behavior. Unfortunately, since the user's smartphone is configured to store only the most recent data locally, the user is relegated to waiting for data to be downloaded from the cloud storage system each time the measurement data from six months prior is queried. In the meantime, local storage space at the smartphone that can be accessed much more quickly is occupied by the unsought measurement data from the user's week of rest.

Systems and methods of the present disclosure provide a more intelligent solution for coordinating the storage of measurement data between a UE and a cloud storage system. Invention embodiments provide a hybrid hashing scheme that enables measurement data to be accessed quickly and prioritized for local storage based on user's querying behavior. Some embodiments may include an indexing/hashing structure with lists at two levels.

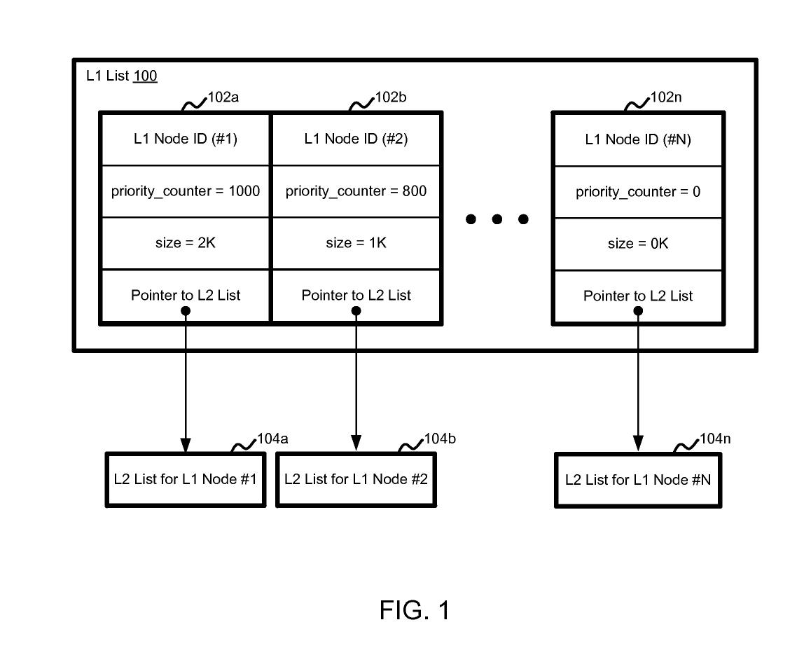

FIG. 1 illustrates an example of first level (L1) list 100 of an indexing/hashing structure in accordance with an example. For simplicity, the L1 list 100 of this example is described as an array. However, other list structures, such as linked lists or vectors, may also be used. The L1 list 100 may comprise L1 nodes 102a-n. In this example, the nodes 102a-n are described as objects (e.g., in an object-oriented programming language such as Java or C++). However, the L1 nodes 102a-n may also be of any composite data type (e.g., Structs in C or records in TurboPascal) that permits the L1 nodes 102a-n to be designed as described. In addition, while lower case letters are used for convenience in identifying the three nodes shown, it is to be understood that the L1 list 100 may generally include an arbitrary number of L1 nodes.

Each of the L1 nodes 102a-n may comprise instance variables such as a priority counter, a size, a node identification (ID) number, and a pointer to a respective second level (L2) list 104a-n associated with the respective node. The priority counter, the size, and the node ID may be of one or more primitive numerical data types. Each size instance variable may indicate an amount of digital memory used to store measurement data associated with the respective L1 node. Each priority counter instance variable may indicate a number of times that measurement data in the respective L2 list associated with the respective L1 node has been queried or accessed. Alternatively, the value of a priority counter instance variable may also be determined based on other types of schemes (e.g., wherein time elapsed since an L1 node's L2 list was last accessed is used to determine a weighting and outlier handling is provided). The L1 nodes 102a-n may be sorted in the L1 list 100 according to their respective priority counter instance variables. While a pointer is depicted as an instance variable for each node shown in FIG. 1, it is to be understood that another type of indicator of a digital-memory address (e.g., a reference) may also be used.

Each of the L1 nodes 102a-n may be associated with a respective type of measurement data received from sensors. For example, one of the L1 nodes 102a-n may be associated with heart rate measurements, while another might be associated with temperature measurements, accelerometer measurements, or another type of measurement. In some examples, different L1 nodes might represent subtypes of more general types of measurement data. In these examples, an indexing function may be provided. The indexing function may be used to indicate list indices (e.g., array indices) or node ID numbers of L1 nodes in the L1 list 100 that are associated with subtypes of a general type.

The L1 nodes 102a-n in the L1 list may be sorted according to their respective priority counter instance variable values. Though FIG. 1 illustrates that the L1 nodes 102a-n are sorted in descending order from left to right, it is to be understood that the functionality described herein may also be accomplished with trivial adjustments if the L1 nodes 102a-n were sorted in ascending order.

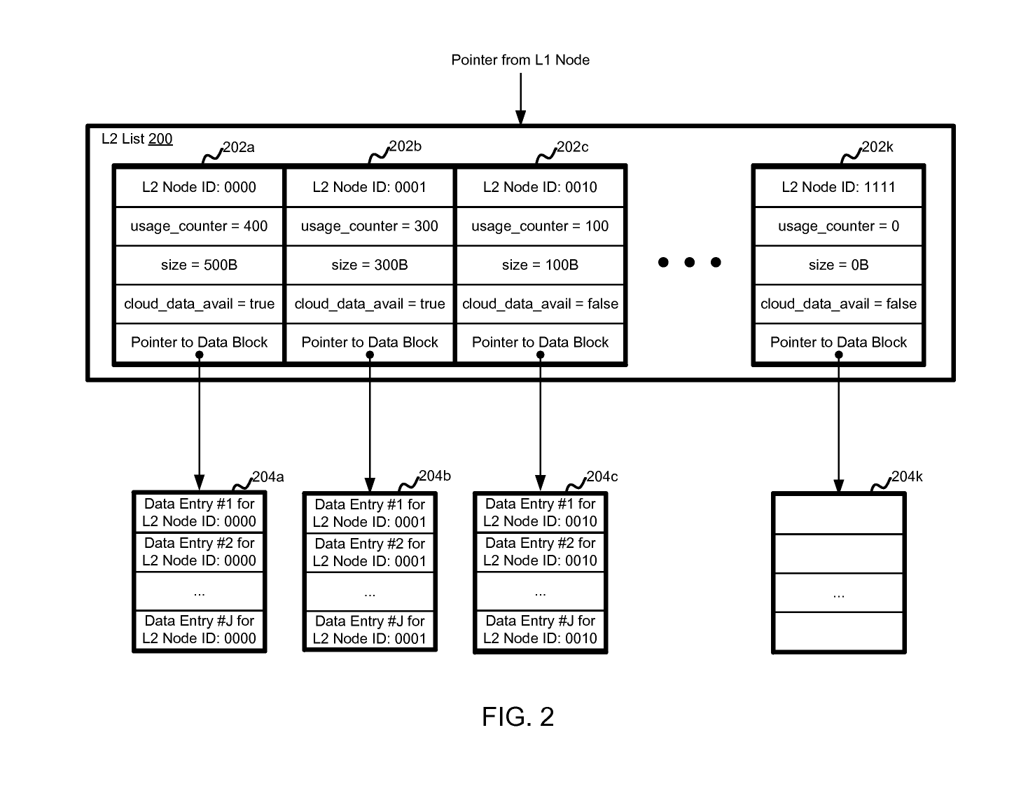

FIG. 2 illustrates a detailed example of an L2 list 200 in accordance with an example. The L2 list 200 may be a hash table. The L2 list 200 may comprise L2 nodes 202a-k. Each of the L2 nodes 202a-k may correspond to a hash-table bucket of the L2 list 200.

In this example, the L2 nodes 202a-k are described as objects (e.g., in an object-oriented programming language such as Java or C++). However, the L2 nodes 202a-k may also be of any composite data type (e.g., Structs in C or records in TurboPascal) that permits the L2 nodes 202a-k to be designed as described. In addition, while lower case letters are used for convenience in identifying the three nodes shown, it is to be understood that the L2 list 200 may generally include an arbitrary number of L2 nodes.

Each L2 node 202a-k may comprise instance variables such as a node identification (ID) number (which may also be a binary hash key associated with the respective L2 node), a usage counter, a size, a cloud data availability indicator, and a pointer to a block of digital memory wherein data entries of sensor measurements associated with the respective L2 node may be stored. In FIG. 2, the blocks of digital memory 204a-k are therefore associated with the L2 nodes 202a-k. Each respective block of digital memory associated with a respective L2 node may contain a predefined number of bits or bytes.

The usage counter, the size, and the node ID number may be of one or more primitive numerical data types. The cloud data availability indicator may be of a Boolean data type or a primitive numerical data type. Each size instance variable may indicate an amount of digital memory used to store data entries of sensor measurements associated with the respective L2 node. The size may be zero, as shown for L2 node 202k, if there are no data entries of sensor measurements currently stored in the L2 node's associated block of digital memory (block of digital memory 204k, in this example). If an L2 node's entire associated block of digital memory is being used to store data entries of sensor measurements, the size variable may be a maximum value.

Each usage counter instance variable may indicate a number of times that measurement data in the respective block of digital memory associated with the respective L2 node has been queried or accessed. In some examples, the priority counter of an L1 node that points to an L2 list may be the sum of the usage counters of L2 nodes in the L2 list. While a pointer is depicted as an instance variable for each L2 node shown in FIG. 2, it is to be understood that another type of indicator of a digital-memory address (e.g., a reference) may also be used.

A hashing function associated with the L2 list 200 may be designed to be applied to measurement data such that sensor measurements that are stored in the block of digital memory associated with a respective L2 node were taken during a specific period of time. In other words, for sensor measurements taken during that specific period of time, the hash function can produce the same hash key so that the sensor measurements are placed in the same bucket. In this manner, measurement data (e.g., data entries of sensor measurements) from a time period can be stored in a single block of digital memory. Designing the hashing function in this manner allows spatial locality of sensor measurements in memory to reflect temporal locality of the sensor measurements with regard to when the sensor measurements were taken.

In examples where each L2 node is associated with a respective binary hash key (e.g., as the node ID or hash key of a corresponding bucket), a problem may arise if the hash function maps an additional sensor measurement to an L2 node whose associated block of digital memory is full of existing sensor measurements. One solution would be to allocate a larger block of memory, copy both the existing sensor measurements and the new sensor measurement over to the larger block, and set the respective L2 node's pointer to the larger block. This approach, though, is relatively inefficient. Furthermore, this might slow the retrieval of sensor measurements from memory in response to queries, since the hash bucket to which the respective L2 node corresponds would hold a larger number of sensor measurement values.

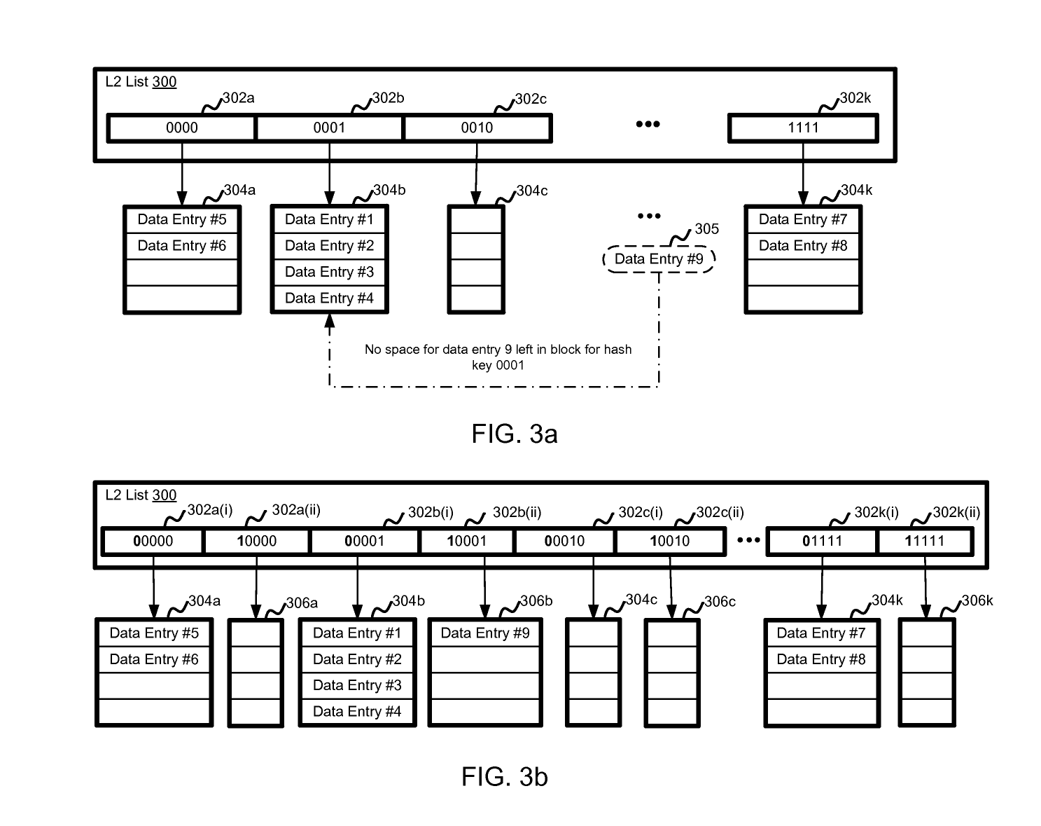

FIGS. 3a-b illustrate a more efficient approach that may be used when a hash function maps an additional sensor measurement to an L2 node whose associated block of digital memory is full of existing sensor measurements. An L2 list 300 may be a hash table that includes L2 nodes 302a-k. The L2 nodes 302a-k may include pointers (or other indicators of memory addresses) to the associated digital memory blocks 304a-k, respectively. Each of the digital memory blocks 304a-k may have a predetermined amount of memory in which up to four sensor measurement data entries may be stored. The L2 nodes 302a-k may be associated with four-bit binary hash keys (e.g., 0000, 0001, 0010, and 1111, as shown). In this example, the L2 nodes 302a-k are described as objects (e.g., in an object-oriented programming language such as Java or C++). However, the L2 nodes 302a-k may also be of any composite data type (e.g., Structs in C or records in TurboPascal) that permits the L2 nodes 302a-k to be designed as described. In addition, while lower case letters are used for convenience in identifying the three nodes shown, it is to be understood that the L2 list 300 may generally include an arbitrary number of L2 nodes.

As shown in FIG. 3a, a sensor measurement data entry 305 may be received for storage or indexing in the L2 list 300. A hash function may be applied to the sensor measurement data entry 305 (data entry #9) to determine that the sensor measurement data entry 305 hashes to a bucket with a hashing index of 0001 and should therefore be stored in the digital memory block 304b. However, the digital memory block 304b may already be filled with four other sensor measurement data entries, as shown.

FIG. 3b illustrates changes that may be applied to the L2 list 300 in order to allow the sensor measurement data entry 305 (data entry #9) to be stored without requiring the sensor measurement data entries that have already been stored in digital memory block 304b to be relocated or copied. The four-bit binary hash key associated with the L2 node 302b can be extended by one extension bit each to form two resultant five-bit hash keys. In some examples, the extension bit may be the most significant bit. The four least significant bits of the two resultant five-bit hash keys may have values identical to the four-bit hash key associated with L2 node 302b, while the most significant bits (MSBs) of the two resultant five-bit hash keys differ. One of the resultant five-bit hash keys can be associated with the L2 node 302b associated with the four-bit hash key. For clarity, in FIG. 3b, once the L2 node 302b is associated with a resultant five-bit hash key (00001), the L2 node 302b is referred to as L2 node 302b(i). Values of instance variables of L2 node 302b(i), such as a pointer to digital memory block 304b, may remain unchanged. An additional L2 node 302b(ii) can be created and associated with the other resultant five-bit hash key (10001). The additional L2 node 302b(ii) may comprise a pointer to an additional digital memory block 306b. The sensor measurement data entry 305 (data entry #9) can then be stored in the digital memory block 306b.

Similar changes may be applied with respect to the L2 nodes 302a and 302c-k. For example, the four-bit hash key of 302a (0000) may be extended to form resultant hash keys (00000 and 10000). One of the resultant hash keys (00000) may be associated with L2 node 302a; for explanatory purposes, L2 node 302a is referred to as L2 node 302a(1) in FIG. 3b. Again, values of instance variables of the L2 node 302a(i), such as a pointer to digital memory block 304a, may remain unchanged. An additional L2 node 302a(ii) can be created and associated with the other resultant five-bit hash key (10000). The additional L2 node 302a(ii) may comprise a pointer to an additional digital memory block 306a. As illustrated, similar changes may be applied with respect to L2 nodes 302c-k such that pointers of L2 nodes 302c(ii) and 302k(ii) point to additional digital memory blocks 306c and 306k, respectively, and pointers of L2 nodes 302c(i) and 302k(i) still point to digital memory blocks 304c and 304k, respectively. The hash function may be updated such that sensor measurement data entries that would have mapped to a single bucket associated with a given four-bit hash code are mapped to one of the two buckets associated with five-bit hash codes whose four least significant bits match the given four-bit hash code.

It should be understood that, although FIGS. 3a-b illustrate extension from four-bit hash codes into five-bit hash codes, the same principles explained for FIGS. 3a-b can be applied to extend hash codes for an L2 list from an arbitrary number of bits x into x+1 bits. As such, the number of bits used hash codes of these examples are not intended to be limiting.

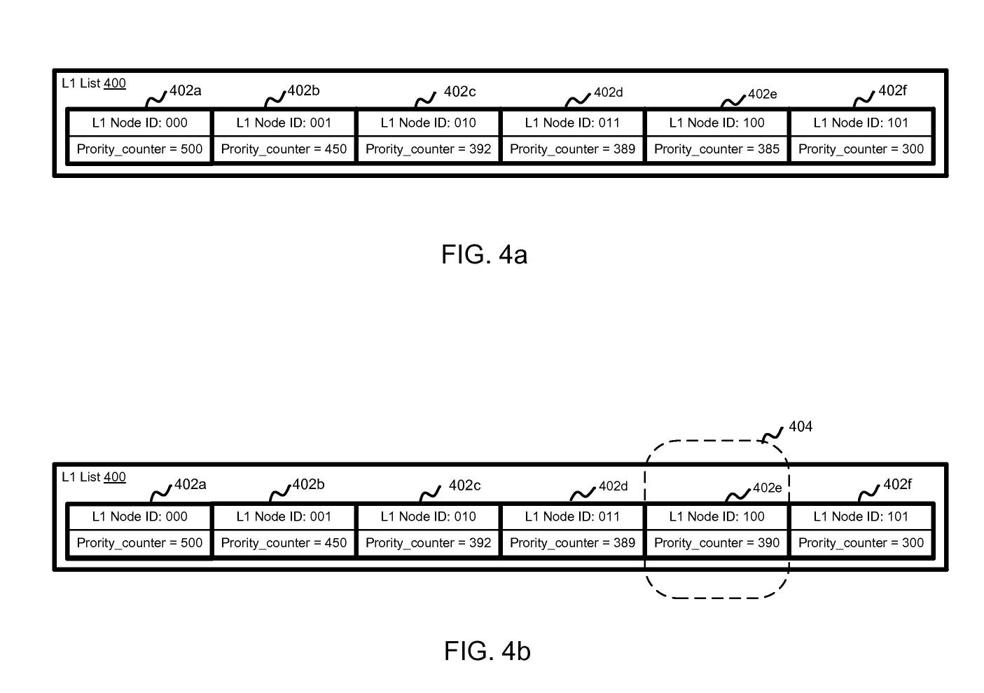

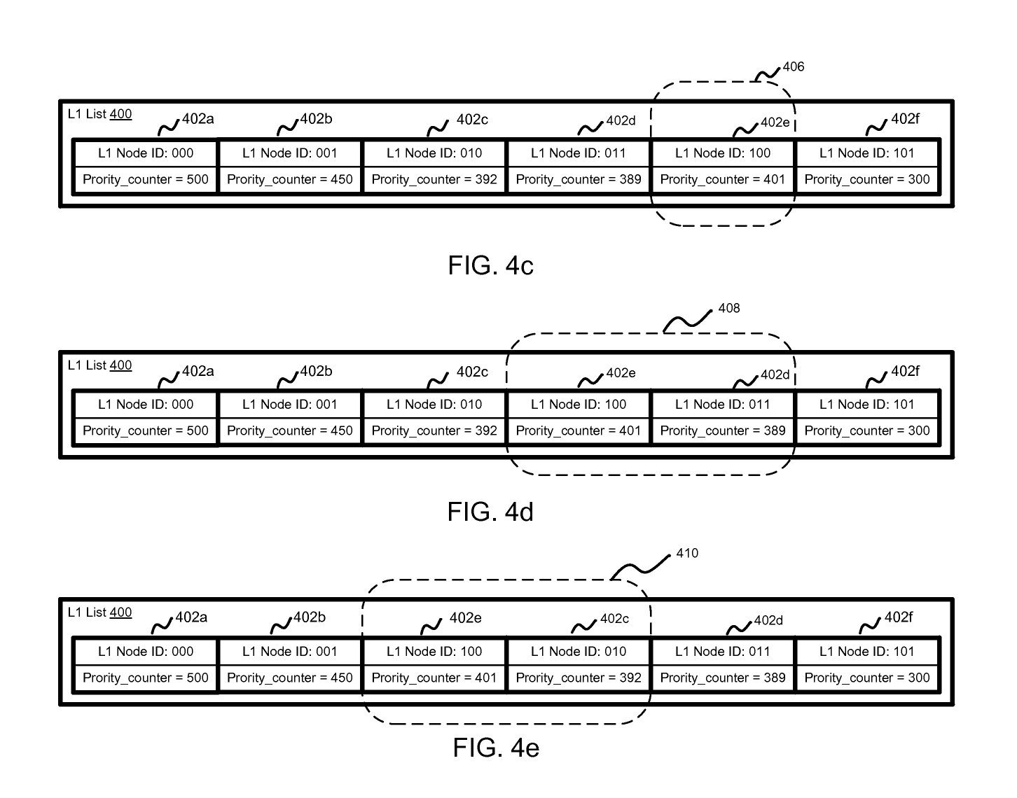

FIGS. 4a-e illustrate an exemplary manner in which an order of L1 nodes 402a-f in an L1 list 400 may be updated as values of priority counter instance variables for the L1 nodes 402a-f change. The order of L1 nodes 402a-f may be updated periodically at fixed time intervals or in response to changes in priority counter values.

As shown in FIG. 4a, the L1 nodes 402a-f may initially be sorted in descending order according to priority counter values. As shown in selection 404 of FIG. 4b, the priority counter for L1 node 402e may be increased from 385 to 390. Since the priority counter for L1 node 402d is only 389, the L1 nodes are no longer sorted in descending order according to their respective priority counters. However, updating the order of the L1 nodes 402a-f may be postponed until a difference between the priority counters of L1 nodes 402e and 402d meets or exceeds a predefined threshold value. The difference may be calculated by subtracting the value of the priority counter of the L1 node 402d (i.e., the L1 node in a position of higher priority in the L1 list 400) from the value of the priority counter of the L1 node 402e (i.e., the L1 node in a position of lower priority in the L1 list 400). In FIGS. 4a-e, as an example, the predefined threshold value may be 7 (though other threshold values, of course, may be used). Since the difference between 389 and 390 is only 1, the order of the L1 nodes 402a-f may not be updated in response to this difference.

As shown in selection 406 of FIG. 4c, the priority counter of L1 node 402e may be increased from 390 to 401 such that the predefined threshold value is exceeded by the difference of the priority counter of L1 node 402e and the priority counter of L1 node 402d.

As shown in FIG. 4d, the positions of L1 node 402e and L1 node 402d in the L1 list 400 may be swapped. After the swapping, the priority counter of L1 node 402e may also be compared to the priority counter of L1 node 402c. Since the difference between the priority counter of L1 node 402e and L1 node 402c is 8, the predefined threshold value is exceeded.

As shown in FIG. 4e, the positions of L1 node 402e and L1 node 402c in the L1 list 400 may be swapped. The priority counter of L1 node 402e may also be compared to the priority counter of L1 node 402b. Since the difference between the priority counter of L1 node 402e and L1 node 402b is −49, the predefined threshold value is not exceeded and no further updates are needed. Again, this difference is calculated by subtracting the value of the priority counter of the L1 node in the position of higher priority in the L1 List 400 from the value of the priority counter of the L1 node in the position of lower priority in the L1 list 400.

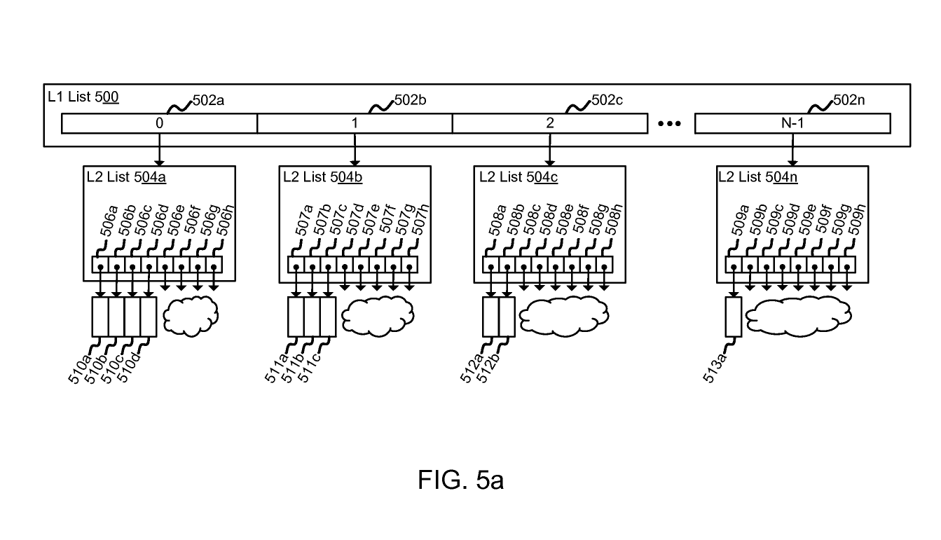

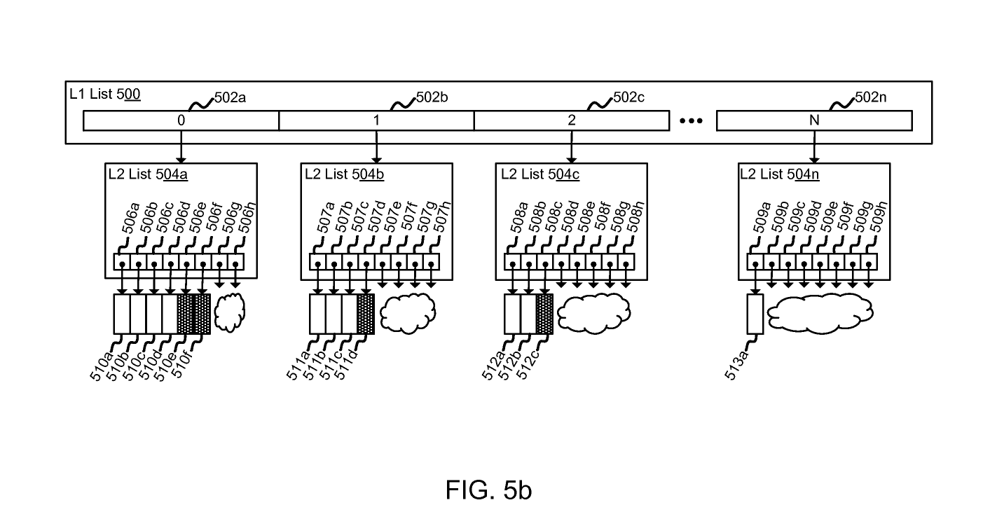

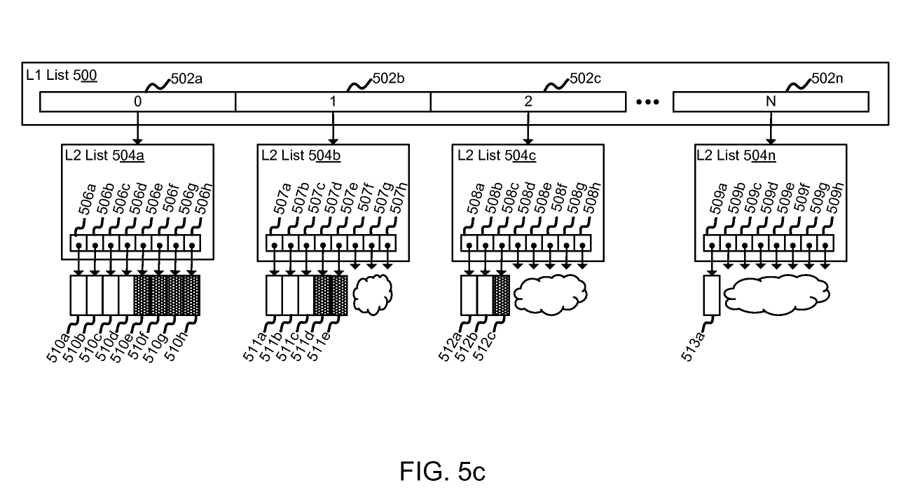

FIGS. 5a-c illustrate states of a hybrid indexing/hashing structure for coordinating data storage between local digital memory of a UE and remote digital memory of a cloud storage system in accordance with an example. An L1 list 500 may comprise L1 nodes 502a-n. The L1 nodes 502a-n may be indexed in the L1 list 500 with indices ranging from 0 to an N-1, where there are N L1 nodes in the L1 nodes 502a-n (though other ranges of indices can be used as long as each L1 node has corresponds to a respective index). The L1 nodes 502a-n may be sorted in descending order with respect to priority (e.g., as measured by instance variable priority counters). There may also be a pivot index selected. In this example, the pivot index may be 2 (which corresponds to L1 node 502c). The pivot index may be used to determine a cutoff priority level for data transfer from the cloud storage system to the UE.

The L1 nodes 502a-n may comprise instance variable pointers to the L2 lists 504a-n, respectively, as shown in FIGS. 5a-c. Each of the L2 lists 504a-n may comprise a set of L2 nodes. For example, L2 list 504a may include L2 nodes 506a-h, L2 list 504b may include L2 nodes 507a-h, L2 list 504c may include L2 nodes 508a-h, and L2 list 504n may include L2 nodes 509a-h. Each of the L2 lists 504a-n may comprise a hash table such that each L2 node is associated with a bucket of the hash table. A hashing function of a hash table may map data entries to buckets in a manner such that data entries assigned to a common bucket have temporal locality relative to each other.

Each L2 node may comprise an instance variable pointer to a block of digital memory that may be local (e.g., at the UE) or remote (e.g., at the cloud storage system). For example, as shown in FIG. 5a, L2 nodes 506a-d may have pointers to local digital memory blocks 510a-d, respectively, while L2 nodes 506e-h may have pointers to remote digital memory blocks (depicted by a cloud in FIGS. 5a-c). In a similar fashion, L2 nodes 507a-c may include pointers to local digital memory blocks 511a-c, respectively, and L2 nodes 507d-h may include pointers to remote digital memory blocks. L2 nodes 508a-b may include pointers to local digital memory blocks 512a-b, respectively, and L2 nodes 508c-h may include pointers to remote digital memory blocks. L2 node 509a may include a pointer to local digital memory block 513a, respectively, and L2 nodes 509b-h may include pointers to remote digital memory blocks. Each data block may be the place where data entries for the bucket corresponding to the respective L2 node are stored.

It may be determined that additional local digital memory is available for storing measurement data at the UE. A first round of data transfer from the cloud storage system to the UE as shown in FIG. 5b may commence as follows. Since L1 node 502a is in the position of highest priority in the sorted L1 list 500, two additional local digital memory blocks 510e-f can be allocated for measurement data of the L2 list 504a. Pointers of the L2 nodes 506e-f can be directed to the local digital memory blocks 510e-f. Existing data entries for buckets corresponding to L2 nodes 506e-f can be downloaded from the cloud storage system and copied into the local digital memory blocks 510e-f, respectively.

Since L1 node 502b is in the position of second-highest priority in the sorted L1 list 500, an additional local digital memory block 511d can be allocated for measurement data of the L2 list 504b. A pointer of the L2 node 507d can be directed to the local digital memory block 511d. Existing data entries for a bucket corresponding to L2 node 507d can be downloaded from the cloud storage system and copied into the local digital memory block 511d.

Since L1 node 502c corresponds to the pivot index (i.e., L1 node 502c has a sufficiently high priority), an additional local digital memory block 512c can be allocated for measurement data of the L2 list 504c. A pointer of the L2 node 508c can be directed to the local digital memory block 512c. Existing data entries for a bucket corresponding to L2 node 508c can be downloaded from the cloud storage system and copied into the local digital memory block 512c.

Since L1 node 502n corresponds to an index of lower priority than the pivot index, the pointers of L2 nodes 509b-h may remain directed to remote digital memory blocks.

It may be determined that three additional blocks of local digital memory are still available for storing measurement data at the UE. A second round of data transfer from the cloud storage system to the UE as shown in FIG. 5c may commence as follows. Since L1 node 502a remains in the position of highest priority in the sorted L1 list 500, two additional local digital memory blocks 510g-h can be allocated for measurement data of the L2 list 504a. Pointers of the L2 nodes 506g-h can be directed to the local digital memory blocks 510g-h. Existing data entries for buckets corresponding to L2 nodes 506g-h can be downloaded from the cloud storage system and copied into the local digital memory blocks 510g-h, respectively.

Since L1 node 502b is in the position of second-highest priority in the sorted L1 list 500, an additional local digital memory block 511e can be allocated for measurement data of the L2 list 504b. A pointer of the L2 node 507e can be directed to the local digital memory block 511e. Existing data entries for a bucket corresponding to L2 node 507e can be downloaded from the cloud storage system and copied into the local digital memory block 511e.

While L1 node 502c corresponds to the pivot index (i.e., L1 node 502c has a sufficiently high priority), a limit for local storage space may have been reached. Hence, no additional measurement data is downloaded from the cloud storage system.

The example shown in FIGS. 5a-c and explained above serves to demonstrate some aspects of methods and systems to coordinate storage of measurement data between a local device and a cloud storage system. For example, more local blocks may be allocated for L2 lists whose corresponding L1 nodes have higher priority (as determined by the order of L1 nodes in the L1 list). Local blocks may be allocated on a round-by-round basis, in descending order according to priority as indicated by the indices of the L1 list, for L1 nodes (and their corresponding L2 lists) until no additional local digital memory is available.

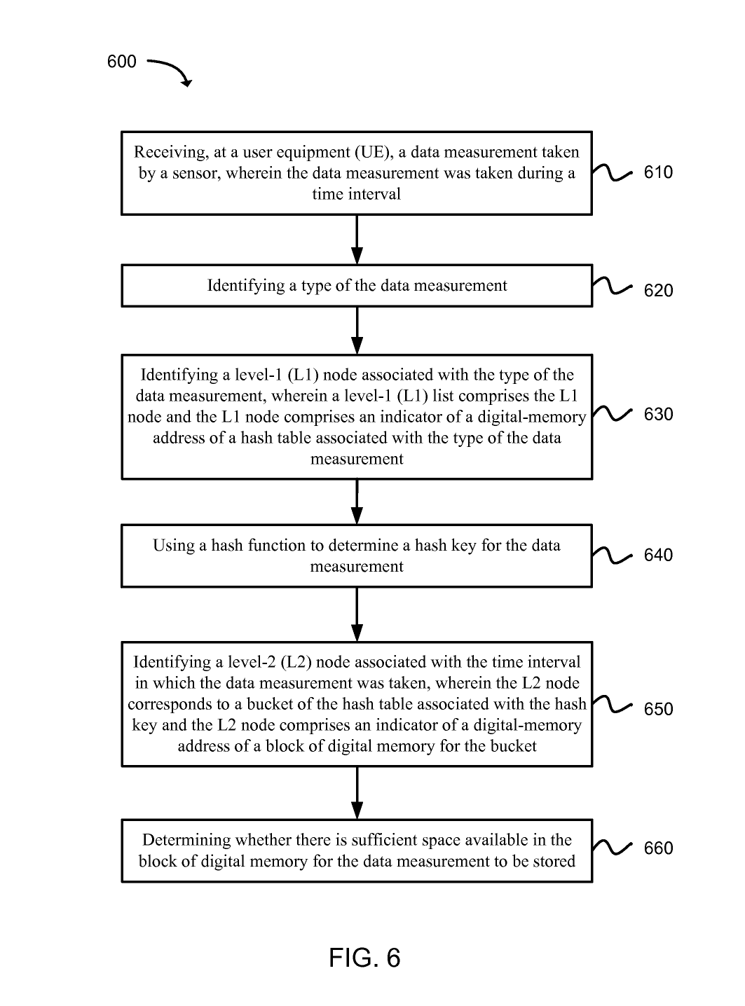

FIG. 6 illustrates functionality 600 for storing data measurements for efficient retrieval in accordance with an example. The functionality can be implemented as instructions stored and executed on a machine, where the instructions are included on at least one non-transitory computer-readable storage medium.

As in block 610, the functionality 600 may include receiving, at a user equipment (UE), a data measurement taken by a sensor, wherein the data measurement was taken during a time interval.

As in block 620, the functionality 600 may include identifying a type of the data measurement.

As in block 630, the functionality 600 may include identifying a level-1 (L1) node associated with the type of the data measurement, wherein a level-1 (L1) list comprises the L1 node and the L1 node comprises an indicator of a digital-memory address of a hash table associated with the type of the data measurement. The L1 node may also comprise a size instance variable indicating an amount of digital memory being used to store data measurements that are accessible through the hash table.

As in block 640, the functionality 600 may include using a hash function to determine a hash key for the data measurement.

As in block 650, the functionality 600 may include identifying a level-2 (L2) node associated with the time interval in which the data measurement was taken, wherein the L2 node corresponds to a bucket of the hash table associated with the hash key and the L2 node comprises an indicator of a digital-memory address of a block of digital memory for the bucket. The L2 node may also comprise a usage counter that is an instance variable reflecting a frequency with which data measurements stored for the bucket corresponding to the L2 node are queried, a size instance variable indicating an amount of digital memory being used to store data measurements in the block of digital memory, or a remote-storage-availability instance variable indicating whether data measurements stored in the block of digital memory are stored remotely relative to the UE.

In some examples, the functionality 600 may also include identifying that there is sufficient space available in the block of digital memory for the data measurement to be stored therein, wherein the block of digital memory is of a predefined size and the predefined size is sufficient for the block of digital memory to store one or more data measurements. The functionality 600 may also include issuing a command for the data measurement to be stored in the block of digital memory based on the determination. The block of digital memory may be at a local device or at a remote data store.

Conversely, in other examples, the functionality 600 may also include identifying that there is not sufficient space available in the block of digital memory for the data measurement to be stored therein, wherein the block of digital memory is of a predefined size and the predefined size is sufficient for the block of digital memory to store one or more data measurements, and wherein the hash key comprises a predefined number of bits N. The functionality 600 may also include creating an a first expansion hash key comprising N+1 bits and a second expansion hash key having N+1 bits, wherein the first expansion hash key and the second expansion hash key have differing most-significant-bit values and the remaining N bits of both the first expansion hash key and the second expansion hash key have values equal to the N bits of the hash key. Further, the functionality 600 may also include associating the first expansion hash key with the bucket of the hash table and with the block of digital memory. The functionality 600 may also include associating the second expansion hash key with an additional bucket of the hash table and with an additional block of digital memory. The functionality 600 may also include issuing a command for the data measurement to be stored in the additional block of digital memory.

In some examples, additional L1 nodes may be elements of the L1 List, each L1 node that is an element of the L1 List may comprise a respective element priority counter that is an instance variable; the L1 list may be sorted based on element priority counters.

As in block 660, the functionality 600 may include determining whether there is sufficient space available in the block of digital memory for the data measurement to be stored

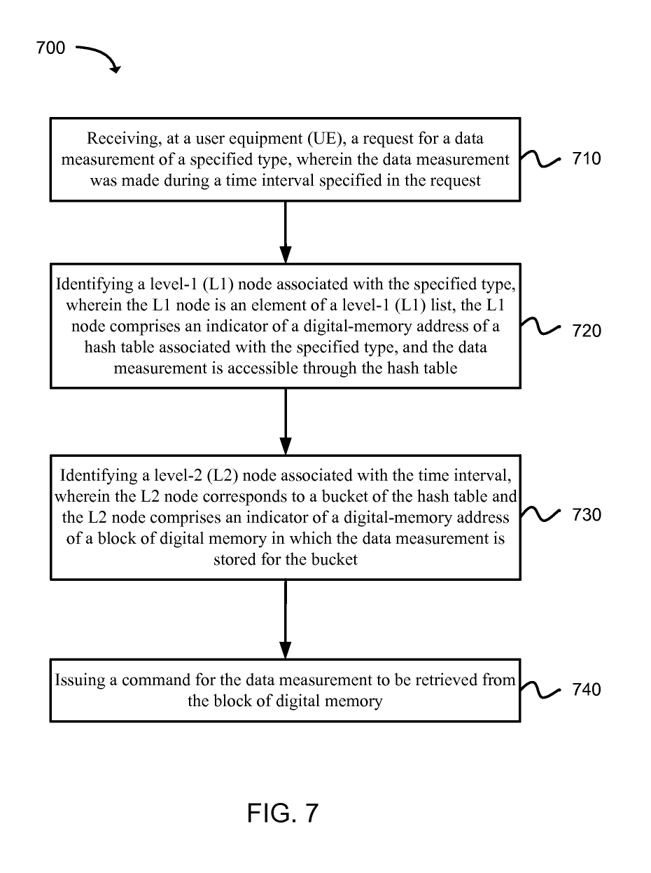

FIG. 7 illustrates functionality 700 for retrieving a data measurement from digital memory in accordance with an example. The functionality can be implemented as instructions stored and executed on a machine, where the instructions are included on at least one non-transitory computer-readable storage medium.

As in block 710, the functionality 700 may include receiving, at a user equipment (UE), a request for a data measurement of a specified type, wherein the data measurement was made during a time interval specified in the request.

As in block 720, the functionality 700 may include identifying a level-1 (L1) node associated with the specified type, wherein the L1 node is an element of a level-1 (L1) list, the L1 node comprises an indicator of a digital-memory address of a hash table associated with the specified type, and the data measurement is accessible through the hash table. The L1 node may comprise a size instance variable indicating an amount of digital memory being used to store data measurements that are accessible through the hash table. As in block 730, the functionality 700 may include identifying a level-2 (L2) node associated with the time interval, wherein the L2 node corresponds to a bucket of the hash table and the L2 node comprises an indicator of a digital-memory address of a block of digital memory in which the data measurement is stored for the bucket. The L2 node may further comprise a size instance variable indicating an amount of digital memory being used to store data measurements in the block of digital memory or a remote-storage-availability instance variable indicating whether data measurements stored in the block of digital memory are stored remotely relative to the UE. Identifying the L2 node associated with the time interval in which the data measurement was taken may be achieved by applying a hashing function to a datum associated with the data measurement.

In some examples, additional L1 nodes may be elements of the L1 List, each L1 node that is an element of the L1 List may comprise a respective element priority counter that is an instance variable, and the L1 list can be sorted based on element priority counters. In such examples, the functionality 700 may include incrementing an element priority counter of the L1 node, comparing the element priority counter of the L1 node to an element priority counter of a neighboring L1 node in the L1 List, and swapping a position of the L1 node and a position of the neighboring node in the L1 list based on the comparison of the element priority counter of the L1 node to the element priority counter of the neighboring L1 node. In these examples, the functionality 700 may also include determining a difference between the element priority counter of the L1 node to an element priority counter of a neighboring L1 node in the L1 list, verifying that the difference meets or exceeds a predefined threshold value, and swapping an initial position of the L1 node and an initial position of the neighboring L1 node in the L1 list based on the verification such that a resultant position of the L1 node is the initial position of the neighboring L1 node and a resultant position of the neighboring L1 node is the initial position of the L1 node.

Furthermore, in such examples, additional L2 nodes may correspond to additional respective buckets in the hash table and each respective L2 node may comprise a usage counter that is an instance variable reflecting a frequency with which data measurements stored for a respective bucket corresponding to the respective L2 node are requested. In addition, in such examples, the functionality 700 may also include comparing the resultant position of the L1 node to a predefined pivot position and issuing a command for a plurality of data measurements accessible through the hash table to be downloaded via a network connection and stored in a local block of digital memory at the UE based on the comparison of the resultant position of the L1 node to the predefined pivot position. Alternatively, the functionality 700 may include comparing the resultant position of the neighboring L1 node to a predefined pivot position and issuing a command for a plurality of data measurements accessible through a hash referenced by the neighboring L1 node to be uploaded via a network connection and stored in a remote block of digital memory based on the comparison of the resultant position of the neighboring L1 node to the predefined pivot position.

As in block 740, the functionality 700 may include issuing a command for the data measurement to be retrieved from the block of digital memory.

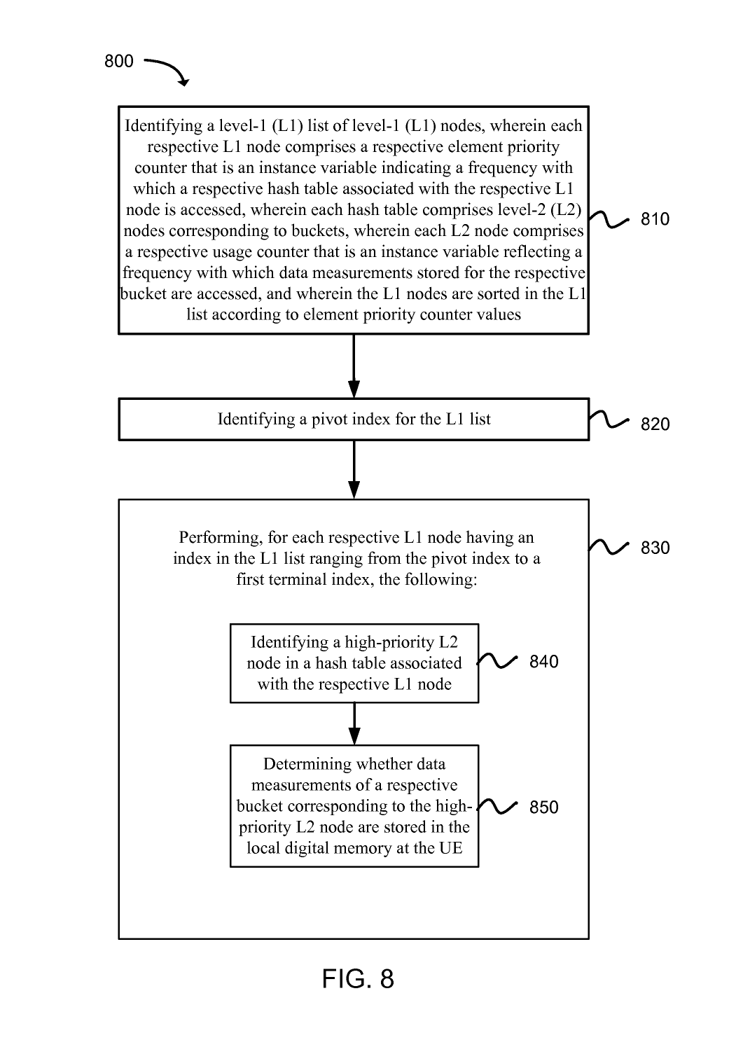

FIG. 8 illustrates functionality 800 for coordinating storage of data measurements between local digital memory at a UE and a remote data store in accordance with an example. The functionality can be implemented as instructions stored and executed on a machine, where the instructions are included on at least one non-transitory computer-readable storage medium.

As in block 810, the functionality 800 may include identifying a level-1 (L1) list of level-1 (L1) nodes, wherein each respective L1 node comprises a respective element priority counter that is an instance variable indicating a frequency with which a respective hash table associated with the respective L1 node is accessed, wherein each hash table comprises level-2 (L2) nodes corresponding to buckets, wherein each L2 node comprises a respective usage counter that is an instance variable reflecting a frequency with which data measurements stored for the respective bucket are accessed, and wherein the L1 nodes are sorted in the L1 list according to element priority counter values.

As in block 820, the functionality 800 may include identifying a pivot index for the L1 list.

As in block 830, the functionality 800 may include performing, for each respective L1 node having an index in the L1 list ranging from the pivot index to a first terminal index (e.g., the index of the L1 node with a highest priority in the L1 list), the actions of block 840 and block 850. A terminal index, as used herein, may refer the index of the first node in a list or the index of a last node in a list. Hence, if the L1 list is sorted in descending order according to priority, the L1 node with the lowest numerical index (which is a terminal index) in the L1 list may have the highest priority and the L1 node with the highest numerical index (which is also a terminal index) in the L1 list may have the lowest priority relative to all nodes in the list. Conversely, if the L1 list is sorted in ascending order according to priority, the L1 node with the lowest numerical index in the L1 list may have the lowest priority and the L1 node with the highest numerical index may have the highest priority.

As in block 840, the functionality 800 may include identifying a high-priority L2 node in a hash table associated with the respective L1 node.

As in block 850, the functionality 800 may include determining whether data measurements of a respective bucket corresponding to the high-priority L2 node are stored in the local digital memory at the UE.

In some examples, the functionality 800 may also include performing, for at least one L1 node having an index in the L1 list ranging from the pivot index to the first terminal index, the following: identifying a high-priority L2 node in a hash table associated with the at least one L1 node, determining that data measurements of a respective bucket corresponding to the high-priority L2 node are not stored in the local digital memory at the UE, and issuing a request to download the data measurements of the respective bucket corresponding to the high-priority L2 node from the remote data store. The high-priority L2 node may have a usage counter with a value indicating that data measurements stored for the respective bucket corresponding to the high-priority L2 node are accessed frequently.

In further examples, the functionality 800 may also include performing, for the at least one L1 node having an index in the L1 list ranging from the pivot index to the first terminal index, the following: determining that data measurements of the respective bucket corresponding to the high-priority L2 node are likely to be accessed because the data measurements in the respective bucket were taken during a range of time in which frequently-accessed data measurements were taken, and identifying the high-priority L2 node in the hash table associated with the at least one L1 node based on the determination that data measurements of the respective bucket corresponding to the high-priority L2 node are likely to be accessed.

In addition, in some examples, the functionality 800 may include performing, for each respective L1 node having an index in the L1 list ranging from the pivot index to a second terminal index (e.g., an index of an L1 node with a lowest priority in the L1 list), the following: identifying one or more L2 nodes in a hash table associated with the respective L1 node, wherein the one or more L2 nodes correspond to buckets for which data measurements are stored in the local digital memory at the UE, and deleting the data measurements that are stored for the buckets corresponding to the one or more L2 nodes from the local digital memory. In such examples, the functionality 800 may also include performing, for each respective L1 node having an index in the L1 list ranging from the pivot index to the second terminal index, the following: (1) identifying one or more non-backed-up L2 nodes in a hash table associated with the respective L1 node, wherein the one or more L2 nodes correspond to buckets for which data measurements are stored in the local digital memory at the UE, and wherein each L2 node comprises an instance variable indicating whether the respective L2 node is backed up at the remote data store; (2) sending the data measurements that are stored for the buckets corresponding to the one or more non-backed-up L2 nodes to the remote data store via a network connection; and (3) deleting the data measurements that are stored for the buckets corresponding to the one or more non-backed-up L2 nodes from the local digital memory.

In some examples, the functionality 800 may include performing, for each respective L1 node having an index in the L1 list ranging from the pivot index to the first terminal index, the following: (1) identifying a number of high-priority L2 nodes in a hash table associated with the respective L1 node, wherein the number of high-priority L2 nodes is based on a respective element priority counter value of the respective L1 node; (2) determining that data measurements of a plurality of respective buckets corresponding to the plurality of high-priority L2 node are not stored in the local digital memory at the UE; and (3) issuing a request to download the data measurements of the plurality of respective buckets corresponding to the plurality of high-priority L2 nodes from the remote data store.

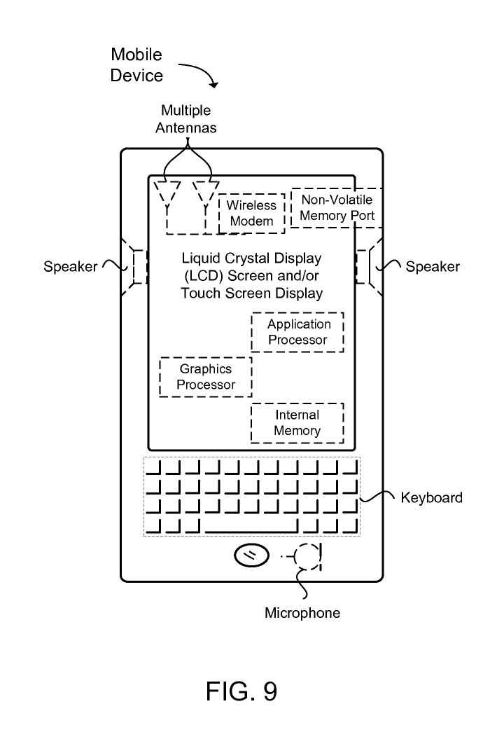

FIG. 9 provides an example illustration of the wireless device, such as a user equipment (UE), a mobile station (MS), a mobile wireless device, a mobile communication device, a tablet, a handset, or other type of wireless device. The wireless device can include one or more antennas configured to communicate with a (cellular network) node, macro node, low power node (LPN), or, transmission station, such as a base station (BS), an evolved Node B (eNB), a baseband processing unit (BBU), a remote radio head (RRH), a remote radio equipment (RRE), a relay station (RS), a radio equipment (RE), or other type of wireless wide area network (WWAN) access point. The wireless device can be configured to communicate using at least one wireless communication standard including 3GPP LTE, WiMAX, High Speed Packet Access (HSPA), Bluetooth, and WiFi. The wireless device can communicate using separate antennas for each wireless communication standard or shared antennas for multiple wireless communication standards. The wireless device can communicate in a wireless local area network (WLAN), a wireless personal area network (WPAN), and/or a WWAN. The wireless device can also comprise a wireless modem. The wireless modem can comprise, for example, a wireless radio transceiver and baseband circuitry (e.g., a baseband processor). The wireless modem can, in one example, modulate signals that the wireless device transmits via the one or more antennas and demodulate signals that the wireless device receives via the one or more antennas.

FIG. 9 also provides an illustration of a microphone and one or more speakers that can be used for audio input and output from the wireless device. The display screen can be a liquid crystal display (LCD) screen, or other type of display screen such as an organic light emitting diode (OLED) display. The display screen can be configured as a touch screen. The touch screen can use capacitive, resistive, or another type of touch screen technology. An application processor and a graphics processor can be coupled to internal memory to provide processing and display capabilities. A non-volatile memory port can also be used to provide data input/output options to a user. The non-volatile memory port can also be used to expand the memory capabilities of the wireless device. A keyboard can be integrated with the wireless device or wirelessly connected to the wireless device to provide additional user input. A virtual keyboard can also be provided using the touch screen.

Various techniques, or certain aspects or portions thereof, can take the form of program code (i.e., instructions) embodied in tangible media, such as floppy diskettes, CD-ROMs, hard drives, non-transitory computer readable storage medium, or any other machine-readable storage medium wherein, when the program code is loaded into and executed by a machine, such as a computer, the machine becomes an apparatus for practicing the various techniques. Circuitry can include hardware, firmware, program code, executable code, computer instructions, and/or software. A non-transitory computer readable storage medium can be a computer readable storage medium that does not include signal. In the case of program code execution on programmable computers, the computing device can include a processor, a storage medium readable by the processor (including volatile and non-volatile memory and/or storage elements), at least one input device, and at least one output device. The volatile and non-volatile memory and/or storage elements can be a RAM, EPROM, flash drive, optical drive, magnetic hard drive, solid state drive, or other medium for storing electronic data. The node and wireless device can also include a transceiver module, a counter module, a processing module, and/or a clock module or timer module. One or more programs that can implement or utilize the various techniques described herein can use an application programming interface (API), reusable controls, and the like. Such programs can be implemented in a high level procedural or object oriented programming language to communicate with a computer system. However, the program(s) can be implemented in assembly or machine language, if desired. In any case, the language can be a compiled or interpreted language, and combined with hardware implementations.

As used herein, the term processor can include general-purpose processors, specialized processors such as VLSI, FPGAs, and other types of specialized processors, as well as base-band processors used in transceivers to send, receive, and process wireless communications.

It should be understood that many of the functional units described in this specification have been labeled as modules, in order to more particularly emphasize their implementation independence. For example, a module can be implemented as a hardware circuit (e.g., an application-specific integrated circuit (ASIC)) comprising custom VLSI circuits or gate arrays, off-the-shelf semiconductors such as logic chips, transistors, or other discrete components. A module can also be implemented in programmable hardware devices such as field programmable gate arrays, programmable array logic, programmable logic devices or the like.

Modules can also be implemented in software for execution by various types of processors. An identified module of executable code can, for instance, comprise one or more physical or logical blocks of computer instructions, which can, for instance, be organized as an object, procedure, or function. Nevertheless, the executables of an identified module need not be physically located together, but can comprise disparate instructions stored in different locations which, when joined logically together, comprise the module and achieve the stated purpose for the module.

Indeed, a module of executable code can be a single instruction, or many instructions, and can even be distributed over several different code segments, among different programs, and across several memory devices. Similarly, operational data can be identified and illustrated herein within modules, and can be embodied in any suitable form and organized within any suitable type of data structure. The operational data can be collected as a single data set, or can be distributed over different locations including over different storage devices, and can exist, at least partially, merely as electronic signals on a system or network. The modules can be passive or active, including agents operable to perform desired functions.

As used herein, the term “processor” can include general purpose processors, specialized processors such as VLSI, FPGAs, and other types of specialized processors, as well as base band processors used in transceivers to send, receive, and process wireless communications.

While the flowcharts presented for this technology may imply a specific order of execution, the order of execution may differ from what is illustrated. For example, the order of two more blocks may be rearranged relative to the order shown. Further, two or more blocks shown in succession may be executed in parallel or with partial parallelization. In some configurations, one or more blocks shown in the flow chart may be omitted or skipped. Any number of counters, state variables, warning semaphores, or messages may be added to the logical flow for enhanced utility, accounting, performance, measurement, troubleshooting, or other purposes.

As used herein, the word “or” indicates an inclusive disjunction. For example, as used herein, the phrase “A or B” represents an inclusive disjunction of exemplary conditions A and B. Hence, “A or B” is false only if both condition A is false and condition B is false. When condition A is true and condition B is also true, “A or B” is also true. When condition A is true and condition B is false, “A or B” is true. When condition B is true and condition A is false, “A or B” is true. In other words, the term “or,” as used herein, should not be construed as an exclusive disjunction. The term “xor” is used where an exclusive disjunction is intended.

In this disclosure, “comprises,” “comprising,” “containing” and “having” and the like can have the meaning ascribed to them in U.S. Patent law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the compositions nature or characteristics would be permissible if present under the “consisting essentially of” language, even though not expressly recited in a list of items following such terminology. When using an open ended term in the specification, like “comprising” or “including,” it is understood that direct support should be afforded also to “consisting essentially of” language as well as “consisting of” language as if stated explicitly and vice versa.

“The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

Reference throughout this specification to “an example” means that a particular feature, structure, or characteristic described in connection with the example is included in at least one embodiment. Thus, appearances of the phrases “in an example” in various places throughout this specification are not necessarily all referring to the same embodiment.

As used herein, a plurality of items, structural elements, compositional elements, and/or materials can be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and examples can be referred to herein along with alternatives for the various components thereof. It is understood that such embodiments, examples, and alternatives are not to be construed as de facto equivalents of one another, but are to be considered as separate and autonomous.

Furthermore, the described features, structures, or characteristics can be combined in any suitable manner in one or more embodiments. In the foregoing description, numerous specific details are provided, such as examples of layouts, distances, network examples, etc., to provide a thorough understanding of some embodiments. One skilled in the relevant art will recognize, however, that the some embodiments can be practiced without one or more of the specific details, or with other methods, components, layouts, etc. In other instances, well-known structures, materials, or operations are not shown or described in detail to avoid obscuring aspects of different embodiments.

### EXAMPLE EMBODIMENTS

In an exemplary embodiment there is provided, a method for storing data measurements for efficient retrieval, the method comprising:

receiving, at a user equipment (UE), a data measurement taken by a sensor, wherein the data measurement was taken during a time interval;

identifying a type of the data measurement;

identifying a level-1 (L1) node associated with the type of the data measurement, wherein a level-1 (L1) list comprises the L1 node and the L1 node comprises an indicator of a digital-memory address of a hash table associated with the type of the data measurement; using a hash function to determine a hash key for the data measurement;

identifying a level-2 (L2) node associated with the time interval in which the data measurement was taken, wherein the L2 node corresponds to a bucket of the hash table associated with the hash key and the L2 node comprises an indicator of a digital-memory address of a block of digital memory for the bucket; and

determining whether there is sufficient space available in the block of digital memory for the data measurement to be stored.

In one embodiment, the method of storing data can further comprise:

identifying that there is sufficient space available in the block of digital memory for the data measurement to be stored therein, wherein the block of digital memory is of a predefined size and the predefined size is sufficient for the block of digital memory to store one or more data measurements; and

issuing a command for the data measurement to be stored in the block of digital memory based on the determination.

In one embodiment the method of storing data can further comprise:

identifying that there is not sufficient space available in the block of digital memory for the data measurement to be stored therein, wherein the block of digital memory is of a predefined size and the predefined size is sufficient for the block of digital memory to store one or more data measurements, and wherein the hash key comprises a predefined number of bits N;

creating an a first expansion hash key comprising N+1 bits and a second expansion hash key having N+1 bits, wherein the first expansion hash key and the second expansion hash key have differing most-significant-bit values and the remaining N bits of both the first expansion hash key and the second expansion hash key have values equal to the N bits of the hash key;

associating the first expansion hash key with the bucket of the hash table and with the block of digital memory;

associating the second expansion hash key with an additional bucket of the hash table and with an additional block of digital memory; and

issuing a command for the data measurement to be stored in the additional block of digital memory.

In one embodiment of a method for storing data, the additional L1 nodes are elements of the L1 List, each L1 node that is an element of the L1 List comprises a respective element priority counter that is an instance variable, and the L1 list is sorted based on element priority counters.

In one embodiment of a method for storing data, the L1 node further comprises a size instance variable indicating an amount of digital memory being used to store data measurements that are accessible through the hash table.

In one embodiment of a method for storing data, the L2 node further comprises at least one of:

a usage counter that is an instance variable reflecting a frequency with which data measurements stored for the bucket corresponding to the L2 node are queried;

a size instance variable indicating an amount of digital memory being used to store data measurements in the block of digital memory; or

a remote-storage-availability instance variable indicating whether data measurements stored in the block of digital memory are stored remotely relative to the UE.

In one embodiment there is provided, a method for retrieving a data measurement from digital memory, the method comprising:

receiving, at a user equipment (UE), a request for a data measurement of a specified type, wherein the data measurement was made during a time interval specified in the request;

identifying a level-1 (L1) node associated with the specified type, wherein the L1 node is an element of a level-1 (L1) list, the L1 node comprises an indicator of a digital-memory address of a hash table associated with the specified type, and the data measurement is accessible through the hash table;

identifying a level-2 (L2) node associated with the time interval, wherein the L2 node corresponds to a bucket of the hash table and the L2 node comprises an indicator of a digital-memory address of a block of digital memory in which the data measurement is stored for the bucket; and

issuing a command for the data measurement to be retrieved from the block of digital memory.

In one embodiment of a method for retrieving data, additional L1 nodes are elements of the L1 List, each L1 node that is an element of the L1 List comprises a respective element priority counter that is an instance variable, and the L1 list is sorted based on element priority counters.

In one embodiment, the method of retrieving data further comprises:

incrementing an element priority counter of the L1 node;

comparing the element priority counter of the L1 node to an element priority counter of a neighboring L1 node in the L1 List; and

swapping a position of the L1 node and a position of the neighboring node in the L1 list based on the comparison of the element priority counter of the L1 node to the element priority counter of the neighboring L1 node.

In one embodiment the method of retrieving data further comprises:

determining a difference between the element priority counter of the L1 node to an element priority counter of a neighboring L1 node in the L1 list;

verifying that the difference meets or exceeds a predefined threshold value; and

swapping an initial position of the L1 node and an initial position of the neighboring L1 node in the L1 list, based on the verification, such that a resultant position of the L1 node is the initial position of the neighboring L1 node and a resultant position of the neighboring L1 node is the initial position of the L1 node.

In one embodiment of a method of retrieving data, the additional L2 nodes correspond to additional respective buckets in the hash table and each respective L2 node comprises a usage counter that is an instance variable reflecting a frequency with which data measurements stored for a respective bucket corresponding to the respective L2 node are requested.

In one embodiment, the method of retrieving data further comprises:

comparing the resultant position of the L1 node to a predefined pivot position; and

issuing a command for a plurality of data measurements accessible through the hash table to be downloaded via a network connection and stored in a local block of digital memory at the UE based on the comparison of the resultant position of the L1 node to the predefined pivot position.

In one embodiment, the method of retrieving data further comprises:

comparing the resultant position of the neighboring L1 node to a predefined pivot position; and

issuing a command for a plurality of data measurements accessible through a hash referenced by the neighboring L1 node to be uploaded via a network connection and stored in a remote block of digital memory based on the comparison of the resultant position of the neighboring L1 node to the predefined pivot position.

In one embodiment of a method of retrieving data, identifying the L2 node associated with the time interval in which the data measurement was taken is achieved by applying a hashing function to a datum associated with the data measurement.

In one embodiment of a method of retrieving data, the L1 node further comprises a size instance variable indicating an amount of digital memory being used to store data measurements that are accessible through the hash table.

In one embodiment of a method of retrieving data, the L2 node further comprises at least one of:

a size instance variable indicating an amount of digital memory being used to store data measurements in the block of digital memory; or

a remote-storage-availability instance variable indicating whether data measurements stored in the block of digital memory are stored remotely relative to the UE.

In one embodiment, there is provided a method of coordinating storage of data measurements between local digital memory at a user equipment (UE) and a remote data store, the method comprising:

identifying a level-1 (L1) list of level-1 (L1) nodes, wherein each respective L1 node comprises a respective element priority counter that is an instance variable indicating a frequency with which a respective hash table associated with the respective L1 node is accessed, wherein each hash table comprises level-2 (L2) nodes corresponding to buckets, wherein each L2 node comprises a respective usage counter that is an instance variable reflecting a frequency with which data measurements stored for the respective bucket are accessed, and wherein the L1 nodes are sorted in the L1 list according to element priority counter values; identifying a pivot index for the L1 list;

performing, for each respective L1 node having an index in the L1 list ranging from the pivot index to a first terminal index, the following:
identifying a high-priority L2 node in a hash table associated with the respective L1 node; and
determining whether data measurements of a respective bucket corresponding to the high-priority L2 node are stored in the local digital memory at the UE.

In one embodiment, the method of coordinating storage of data measurements further comprises:

performing, for at least one L1 node having an index in the L1 list ranging from the pivot index to the first terminal index, the following:
identifying a high-priority L2 node in a hash table associated with the at least one L1 node;
determining that data measurements of a respective bucket corresponding to the high-priority L2 node are not stored in the local digital memory at the UE; and
issuing a request to download the data measurements of the respective bucket corresponding to the high-priority L2 node from the remote data store.

In one embodiment of a method of coordinating storage of data measurements, the high-priority L2 node has a usage counter with a value indicating that data measurements stored for the respective bucket corresponding to the high-priority L2 node are accessed frequently.

In one embodiment of a method of coordinating storage of data measurements, the method further comprises:

performing, for the at least one L1 node having an index in the L1 list ranging from the pivot index to the first terminal index, the following:
determining that data measurements of the respective bucket corresponding to the high-priority L2 node are likely to be accessed because the data measurements in the respective bucket were taken during a range of time in which frequently-accessed data measurements were taken; and
identifying the high-priority L2 node in the hash table associated with the at least one L1 node based on the determination that data measurements of the respective bucket corresponding to the high-priority L2 node are likely to be accessed.

In one embodiment, the method of coordinating storage of data measurements further comprises:

performing, for each respective L1 node having an index in the L1 list ranging from the pivot index to a second terminal index, the following:
identifying one or more L2 nodes in a hash table associated with the respective L1 node, wherein the one or more L2 nodes correspond to buckets for which data measurements are stored in the local digital memory at the UE; and
deleting the data measurements that are stored for the buckets corresponding to the one or more L2 nodes from the local digital memory.

In one embodiment, the method of coordinating storage of data measurements further comprises:

performing, for each respective L1 node having an index in the L1 list ranging from the pivot index to the second terminal index, the following:
identifying one or more non-backed-up L2 nodes in a hash table associated with the respective L1 node, wherein the one or more L2 nodes correspond to buckets for which data measurements are stored in the local digital memory at the UE, and wherein each L2 node comprises an instance variable indicating whether the respective L2 node is backed up at the remote data store;
sending the data measurements that are stored for the buckets corresponding to the one or more non-backed-up L2 nodes to the remote data store via a network connection; and
deleting the data measurements that are stored for the buckets corresponding to the one or more non-backed-up L2 nodes from the local digital memory.

In one embodiment, the method of coordinating storage of data measurements further comprises:

performing, for each respective L1 node having an index in the L1 list ranging from the pivot index to the first terminal index, the following:
identifying a number of high-priority L2 nodes in a hash table associated with the respective L1 node, wherein the number of high-priority L2 nodes is based on a respective element priority counter value of the respective L1 node;
determining that data measurements of a plurality of respective buckets corresponding to the plurality of high-priority L2 node are not stored in the local digital memory at the UE; and
   issuing a request to download the data measurements of the plurality of respective buckets corresponding to the plurality of high-priority L2 nodes from the remote data store.

In an example embodiment there is provided a system for storing data, the system comprising:

a sensor configured to gather data; and

a user equipment (UE) configured to receive data from the sensor, said UE comprising circuitry configured to:

receive, a data measurement taken by the sensor, wherein the data measurement was taken during a time interval;

identify a type of the data measurement;

identify a level-1 (L1) node associated with the type of the data measurement, wherein a level-1 (L1) list comprises the L1 node and the L1 node comprises an indicator of a digital-memory address of a hash table associated with the type of the data measurement;

use a hash function to determine a hash key for the data measurement;

identify a level-2 (L2) node associated with the time interval in which the data measurement was taken, wherein the L2 node corresponds to a bucket of the hash table associated with the hash key and the L2 node comprises an indicator of a digital-memory address of a block of digital memory for the bucket; and

determine whether there is sufficient space available in the block of digital memory for the data measurement to be stored.
In one embodiment of a system for storing data, the circuitry is further configured to:
identify that there is sufficient space available in the block of digital memory for the data measurement to be stored therein, wherein the block of digital memory is of a predefined size and the predefined size is sufficient for the block of digital memory to store one or more data measurements; and
   issue a command for the data measurement to be stored in the block of digital memory based on the determination.
In one embodiment of a system for storing data, the circuitry is further configured to:
identify that there is not sufficient space available in the block of digital memory for the data measurement to be stored therein, wherein the block of digital memory is of a predefined size and the predefined size is sufficient for the block of digital memory to store one or more data measurements, and wherein the hash key comprises a predefined number of bits N;
create a first expansion hash key comprising N+1 bits and a second expansion hash key having N+1 bits, wherein the first expansion hash key and the second expansion hash key have differing most-significant-bit values and the remaining N bits of both the first expansion hash key and the second expansion hash key have values equal to the N bits of the hash key;
associate the first expansion hash key with the bucket of the hash table and with the block of digital memory;
associate the second expansion hash key with an additional bucket of the hash table and with an additional block of digital memory; and
   issue a command for the data measurement to be stored in the additional block of digital memory.
In one embodiment of a system for storing data, additional L1 nodes are elements of the L1 List, each L1 node that is an element of the L1 List comprises a respective element priority counter that is an instance variable, and the L1 list is sorted based on element priority counters.
In one embodiment of a system for storing data, the L1 node further comprises a size instance variable indicating an amount of digital memory being used to store data measurements that are accessible through the hash table.
In one embodiment of a system for storing data, the L2 node further comprises at least one of:
a usage counter that is an instance variable reflecting a frequency with which data measurements stored for the bucket corresponding to the L2 node are queried;
a size instance variable indicating an amount of digital memory being used to store data measurements in the block of digital memory; or
a remote-storage-availability instance variable indicating whether data measurements stored in the block of digital memory are stored remotely relative to the UE.
In an example embodiment, a system for retrieving data is provided, the system comprising:
a sensor configured to gather data; and
a user equipment (UE) configured to receive data from the sensor, said UE comprising circuitry configured to:
receive a request for a data measurement of a specified type, wherein the data measurement was made by the sensor during a time interval specified in the request;
identify a level-1 (L1) node associated with the specified type, wherein the L1 node is an element of a level-1 (L1) list, the L1 node comprises an indicator of a digital-memory address of a hash table associated with the specified type, and the data measurement is accessible through the hash table;
identify a level-2 (L2) node associated with the time interval, wherein the L2 node corresponds to a bucket of the hash table and the L2 node comprises an indicator of a digital-memory address of a block of digital memory in which the data measurement is stored for the bucket; and
   issue a command for the data measurement to be retrieved from the block of digital memory.
In one embodiment of a system for retrieving data, additional L1 nodes are elements of the L1 List, each L1 node that is an element of the L1 List comprises a respective element priority counter that is an instance variable, and the L1 list is sorted based on element priority counters.
In one embodiment of a system for retrieving data, the circuitry is further configured to:
increment an element priority counter of the L1 node;
compare the element priority counter of the L1 node to an element priority counter of a neighboring L1 node in the L1 List; and
swap a position of the L1 node and a position of the neighboring node in the L1 list based on the comparison of the element priority counter of the L1 node to the element priority counter of the neighboring L1 node.
In one embodiment of a system for retrieving data, the circuitry is further configured to:
determine a difference between the element priority counter of the L1 node to an element priority counter of a neighboring L1 node in the L1 list;
verifying that the difference meets or exceeds a predefined threshold value; and
swap an initial position of the L1 node and an initial position of the neighboring L1 node in the L1 list, based on the verification, such that a resultant position of the L1 node is the initial position of the neighboring L1 node and a resultant position of the neighboring L1 node is the initial position of the L1 node.
In one embodiment of a system for retrieving data, additional L2 nodes correspond to additional respective buckets in the hash table and each respective L2 node comprises a usage counter that is an instance variable reflecting a frequency with which data measurements stored for a respective bucket corresponding to the respective L2 node are requested.
In one embodiment of a system for retrieving data, the circuitry is further configured to:
compare the resultant position of the L1 node to a predefined pivot position; and
issue a command for a plurality of data measurements accessible through the hash table to be downloaded via a network connection and stored in a local block of digital memory at the UE based on the comparison of the resultant position of the L1 node to the predefined pivot position.
In one embodiment of a system for retrieving data, the circuitry is further configured to:
compare the resultant position of the neighboring L1 node to a predefined pivot position; and
   issue a command for a plurality of data measurements accessible through a hash referenced by the neighboring L1 node to be uploaded via a network connection and stored in a remote block of digital memory based on the comparison of the resultant position of the neighboring L1 node to the predefined pivot position.
In one embodiment of a system for retrieving data, identifying the L2 node associated with the time interval in which the data measurement was taken is achieved by applying a hashing function to a datum associated with the data measurement.
In one embodiment of a system for retrieving data, the L1 node further comprises a size instance variable indicating an amount of digital memory being used to store data measurements that are accessible through the hash table.
In one embodiment of a system for retrieving data, the L2 node further comprises at least one of:
a size instance variable indicating an amount of digital memory being used to store data measurements in the block of digital memory; or
a remote-storage-availability instance variable indicating whether data measurements stored in the block of digital memory are stored remotely relative to the UE.
In another example embodiment, a system for coordinating storage of data measurements is provided, the system comprising:
one or more sensors configured to make data measurements;
a user equipment (UE) configured to receive data from the one or more sensors, the UE comprising local digital memory and circuitry configured to:
identify a level-1 (L1) list of level-1 (L1) nodes, wherein each respective L1 node comprises a respective element priority counter that is an instance variable indicating a frequency with which a respective hash table associated with the respective L1 node is accessed, wherein each hash table comprises level-2 (L2) nodes corresponding to buckets, wherein each L2 node comprises a respective usage counter that is an instance variable reflecting a frequency with which data measurements made by the one or more sensors and stored for the respective bucket are accessed, and wherein the L1 nodes are sorted in the L1 list according to element priority counter values;
identify a pivot index for the L1 list;
perform, for each respective L1 node having an index in the L1 list ranging from the pivot index to a first terminal index, the following:
   identify a high-priority L2 node in a hash table associated with the respective L1 node; and
   determine whether data measurements of a respective bucket corresponding to the high-priority L2 node are stored in the local digital memory at the UE.
In one embodiment of a system for coordinating storage of data measurements, the circuitry is further configured to:
perform, for at least one L1 node having an index in the L1 list ranging from the pivot index to the first terminal index, the following:
   identify a high-priority L2 node in a hash table associated with the at least one L1 node;
   determine that data measurements of a respective bucket corresponding to the high-priority L2 node are not stored in the local digital memory at the UE; and
   issue a request to download the data measurements of the respective bucket corresponding to the high-priority L2 node from a remote data store.
In one embodiment of a system for coordinating storage of data measurements, the high-priority L2 node has a usage counter with a value indicating that data measurements stored for the respective bucket corresponding to the high-priority L2 node are accessed frequently.
In one embodiment of a system for coordinating storage of data measurements, the circuitry is further configured to:
perform, for the at least one L1 node having an index in the L1 list ranging from the pivot index to the first terminal index, the following:
   determine that data measurements of the respective bucket corresponding to the high-priority L2 node are likely to be accessed because the data measurements in the respective bucket were taken during a range of time in which frequently-accessed data measurements were taken; and
   identify the high-priority L2 node in the hash table associated with the at least one L1 node based on the determination that data measurements of the respective bucket corresponding to the high-priority L2 node are likely to be accessed.
In one embodiment of a system for coordinating storage of data measurements, the circuitry is further configured to:
perform, for each respective L1 node having an index in the L1 list ranging from the pivot index to a second terminal index, the following:
   identify one or more L2 nodes in a hash table associated with the respective L1 node, wherein the one or more L2 nodes correspond to buckets for which data measurements are stored in the local digital memory at the UE; and
   delete the data measurements that are stored for the buckets corresponding to the one or more L2 nodes from the local digital memory.
In one embodiment of a system for coordinating storage of data measurements, the circuitry is further configured to:
perform, for each respective L1 node having an index in the L1 list ranging from the pivot index to the second terminal index, the following:
   identify one or more non-backed-up L2 nodes in a hash table associated with the respective L1 node, wherein the one or more L2 nodes correspond to buckets for which data measurements are stored in the local digital memory at the UE, and wherein each L2 node comprises an instance variable indicating whether the respective L2 node is backed up at a remote data store;
   send the data measurements that are stored for the buckets corresponding to the one or more non-backed-up L2 nodes to the remote data store via a network connection; and
   delete the data measurements that are stored for the buckets corresponding to the one or more non-backed-up L2 nodes from the local digital memory.
In one embodiment of a system for coordinating storage of data measurements, the circuitry is further configured to:
perform, for each respective L1 node having an index in the L1 list ranging from the pivot index to the first terminal index, the following:
   identify a number of high-priority L2 nodes in a hash table associated with the respective L1 node, wherein the number of high-priority L2 nodes is based on a respective element priority counter value of the respective L1 node;
   determine that data measurements of a plurality of respective buckets corresponding to the plurality of high-priority L2 node are not stored in the local digital memory at the UE; and
   issue a request to download the data measurements of the plurality of respective buckets corresponding to the plurality of high-priority L2 nodes from a remote data store.
In an example embodiment, a user equipment (UE) is provided, the UE comprising one or more processors configured to:
receive, a data measurement taken by the sensor, wherein the data measurement was taken during a time interval;
identify a type of the data measurement;
identify a level-1 (L1) node associated with the type of the data measurement, wherein a level-1 (L1) list comprises the L1 node and the L1 node comprises an indicator of a digital-memory address of a hash table associated with the type of the data measurement;
use a hash function to determine a hash key for the data measurement;
identify a level-2 (L2) node associated with the time interval in which the data measurement was taken, wherein the L2 node corresponds to a bucket of the hash table associated with the hash key and the L2 node comprises an indicator of a digital-memory address of a block of digital memory for the bucket; and
   determine whether there is sufficient space available in the block of digital memory for the data measurement to be stored.
In one embodiment of a user equipment (UE), the one or more processors are further configured to:
identify that there is sufficient space available in the block of digital memory for the data measurement to be stored therein, wherein the block of digital memory is of a predefined size and the predefined size is sufficient for the block of digital memory to store one or more data measurements; and
   issue a command for the data measurement to be stored in the block of digital memory based on the determination.
In one embodiment of a user equipment (UE), the one or more processors are further configured to:
identify that there is not sufficient space available in the block of digital memory for the data measurement to be stored therein, wherein the block of digital memory is of a predefined size and the predefined size is sufficient for the block of digital memory to store one or more data measurements, and wherein the hash key comprises a predefined number of bits N;
create a first expansion hash key comprising N+1 bits and a second expansion hash key having N+1 bits, wherein the first expansion hash key and the second expansion hash key have differing most-significant-bit values and the remaining N bits of both the first expansion hash key and the second expansion hash key have values equal to the N bits of the hash key;
associate the first expansion hash key with the bucket of the hash table and with the block of digital memory;
associate the second expansion hash key with an additional bucket of the hash table and with an additional block of digital memory; and
issue a command for the data measurement to be stored in the additional block of digital memory.
In one embodiment of a user equipment (UE), additional L1 nodes are elements of the L1 List, each L1 node that is an element of the L1 List comprises a respective element priority counter that is an instance variable, and the L1 list is sorted based on element priority counters.
In one embodiment of a user equipment (UE), the L1 node further comprises a size instance variable indicating an amount of digital memory being used to store data measurements that are accessible through the hash table.
In one embodiment of a user equipment (UE), the L2 node further comprises at least one of:
a usage counter that is an instance variable reflecting a frequency with which data measurements stored for the bucket corresponding to the L2 node are queried;
a size instance variable indicating an amount of digital memory being used to store data measurements in the block of digital memory; or
a remote-storage-availability instance variable indicating whether data measurements stored in the block of digital memory are stored remotely relative to the UE.
In an example embodiment, a user equipment (UE) is provided, the UE comprising one or more processors configured to:
receive a request for a data measurement of a specified type, wherein the data measurement was made by the sensor during a time interval specified in the request;
identify a level-1 (L1) node associated with the specified type, wherein the L1 node is an element of a level-1 (L1) list, the L1 node comprises an indicator of a digital-memory address of a hash table associated with the specified type, and the data measurement is accessible through the hash table;
identify a level-2 (L2) node associated with the time interval, wherein the L2 node corresponds to a bucket of the hash table and the L2 node comprises an indicator of a digital-memory address of a block of digital memory in which the data measurement is stored for the bucket; and
issue a command for the data measurement to be retrieved from the block of digital memory.
In one embodiment of a user equipment (UE), additional L1 nodes are elements of the L1 List, each L1 node that is an element of the L1 List comprises a respective element priority counter that is an instance variable, and the L1 list is sorted based on element priority counters.
In one embodiment of a user equipment (UE), the one or more processors are further configured to:
increment an element priority counter of the L1 node;
compare the element priority counter of the L1 node to an element priority counter of a neighboring L1 node in the L1 List; and
swap a position of the L1 node and a position of the neighboring node in the L1 list based on the comparison of the element priority counter of the L1 node to the element priority counter of the neighboring L1 node.
In one embodiment of a user equipment (UE), the one or more processors are further configured to:
determine a difference between the element priority counter of the L1 node to an element priority counter of a neighboring L1 node in the L1 list;
verifying that the difference meets or exceeds a predefined threshold value; and swap an initial position of the L1 node and an initial position of the neighboring L1 node in the L1 list, based on the verification, such that a resultant position of the L1 node is the initial position of the neighboring L1 node and a resultant position of the neighboring L1 node is the initial position of the L1 node.
In one embodiment of a user equipment (UE), additional L2 nodes correspond to additional respective buckets in the hash table and each respective L2 node comprises a usage counter that is an instance variable reflecting a frequency with which data measurements stored for a respective bucket corresponding to the respective L2 node are requested.
In one embodiment of a user equipment (UE), the one or more processors are further configured to:
compare the resultant position of the L1 node to a predefined pivot position; and issue a command for a plurality of data measurements accessible through the hash table to be downloaded via a network connection and stored in a local block of digital memory at the UE based on the comparison of the resultant position of the L1 node to the predefined pivot position.
In one embodiment of a user equipment (UE), the one or more processors are further configured to:
compare the resultant position of the neighboring L1 node to a predefined pivot position; and
   issue a command for a plurality of data measurements accessible through a hash referenced by the neighboring L1 node to be uploaded via a network connection and stored in a remote block of digital memory based on the comparison of the resultant position of the neighboring L1 node to the predefined pivot position.
In one embodiment of a user equipment (UE), identifying the L2 node associated with the time interval in which the data measurement was taken is achieved by applying a hashing function to a datum associated with the data measurement.
In one embodiment of a user equipment (UE), the L1 node further comprises a size instance variable indicating an amount of digital memory being used to store data measurements that are accessible through the hash table.
In one embodiment of a user equipment (UE), the L2 node further comprises at least one of:
a size instance variable indicating an amount of digital memory being used to store data measurements in the block of digital memory; or
a remote-storage-availability instance variable indicating whether data measurements stored in the block of digital memory are stored remotely relative to the UE.
In an example embodiment, a user equipment (UE) is provided, the UE comprising local digital memory and one or more processors configured to:
identify a level-1 (L1) list of level-1 (L1) nodes, wherein each respective L1 node comprises a respective element priority counter that is an instance variable indicating a frequency with which a respective hash table associated with the respective L1 node is accessed, wherein each hash table comprises level-2 (L2) nodes corresponding to buckets, wherein each L2 node comprises a respective usage counter that is an instance variable reflecting a frequency with which data measurements made by the one or more sensors and stored for the respective bucket are accessed, and wherein the L1 nodes are sorted in the L1 list according to element priority counter values;
identify a pivot index for the L1 list;
perform, for each respective L1 node having an index in the L1 list ranging from the pivot index to a first terminal index, the following:
   identify a high-priority L2 node in a hash table associated with the respective L1 node; and
   determine whether data measurements of a respective bucket corresponding to the high-priority L2 node are stored in the local digital memory at the UE.
In one embodiment of a user equipment (UE), the one or more processors are further configured to:
perform, for at least one L1 node having an index in the L1 list ranging from the pivot index to the first terminal index, the following:
   identify a high-priority L2 node in a hash table associated with the at least one L1 node;
   determine that data measurements of a respective bucket corresponding to the high-priority L2 node are not stored in the local digital memory at the UE; and
issue a request to download the data measurements of the respective bucket corresponding to the high-priority L2 node from a remote data store.
In one embodiment of a user equipment (UE), the high-priority L2 node has a usage counter with a value indicating that data measurements stored for the respective bucket corresponding to the high-priority L2 node are accessed frequently.
In one embodiment of a user equipment (UE), the one or more processors are further configured to:
perform, for the at least one L1 node having an index in the L1 list ranging from the pivot index to the first terminal index, the following:
   determine that data measurements of the respective bucket corresponding to the high-priority L2 node are likely to be accessed because the data measurements in the respective bucket were taken during a range of time in which frequently-accessed data measurements were taken; and
   identify the high-priority L2 node in the hash table associated with the at least one L1 node based on the determination that data measurements of the respective bucket corresponding to the high-priority L2 node are likely to be accessed.
In one embodiment of a user equipment (UE), the one or more processors are further configured to:
perform, for each respective L1 node having an index in the L1 list ranging from the pivot index to a second terminal index, the following:
   identify one or more L2 nodes in a hash table associated with the respective L1 node, wherein the one or more L2 nodes correspond to buckets for which data measurements are stored in the local digital memory at the UE; and
   delete the data measurements that are stored for the buckets corresponding to the one or more L2 nodes from the local digital memory.
In one embodiment of a user equipment (UE), the one or more processors are further configured to:
perform, for each respective L1 node having an index in the L1 list ranging from the pivot index to the second terminal index, the following:
   identify one or more non-backed-up L2 nodes in a hash table associated with the respective L1 node, wherein the one or more L2 nodes correspond to buckets for which data measurements are stored in the local digital memory at the UE, and wherein each L2 node comprises an instance variable indicating whether the respective L2 node is backed up at a remote data store;
   send the data measurements that are stored for the buckets corresponding to the one or more non-backed-up L2 nodes to the remote data store via a network connection; and
   delete the data measurements that are stored for the buckets corresponding to the one or more non-backed-up L2 nodes from the local digital memory.
In one embodiment of a user equipment (UE), the one or more processors are further configured to:
perform, for each respective L1 node having an index in the L1 list ranging from the pivot index to the first terminal index, the following:
   identify a number of high-priority L2 nodes in a hash table associated with the respective L1 node, wherein the number of high-priority L2 nodes is based on a respective element priority counter value of the respective L1 node;
   determine that data measurements of a plurality of respective buckets corresponding to the plurality of high-priority L2 node are not stored in the local digital memory at the UE; and

issue a request to download the data measurements of the plurality of respective buckets corresponding to the plurality of high-priority L2 nodes from a remote data store.

While the forgoing examples are illustrative of the principles used in various embodiments in one or more particular applications, it will be apparent to those of ordinary skill in the art that numerous modifications in form, usage and details of implementation can be made without the exercise of inventive faculty, and without departing from the principles and concepts of the embodiments. Accordingly, it is not intended that the technology be limited, except as by the claims set forth below.

What is claimed is:

1. A user equipment (UE) comprising local digital memory and one or more processors configured to:
identify a level-1 (L1) list of level-1 (L1) nodes, wherein each respective L1 node comprises a respective element priority counter that is an instance variable indicating a frequency with which a respective hash table associated with the respective L1 node is accessed, wherein each hash table comprises level-2 (L2) nodes corresponding to buckets, wherein each L2 node comprises a respective usage counter that is an instance variable reflecting a frequency with which data measurements made by one or more sensors and stored for the respective bucket are accessed, and wherein the L1 nodes are sorted in the L1 list according to element priority counter values;
identify a pivot index for the L1 list;
perform, for each respective L1 node having an index in the L1 list ranging from the pivot index to a first terminal index, the following:
identify a high-priority L2 node in a hash table associated with the respective L1 node; and
determine whether data measurements of a respective bucket corresponding to the high-priority L2 node are stored in the local digital memory at the UE.

2. The UE of claim 1, wherein the one or more processors are further configured to:
perform, for at least one L1 node having an index in the L1 list ranging from the pivot index to the first terminal index, the following:
identify a high-priority L2 node in a hash table associated with the at least one L1 node;
determine that data measurements of a respective bucket corresponding to the high-priority L2 node are not stored in the local digital memory at the UE; and
issue a request to download the data measurements of the respective bucket corresponding to the high-priority L2 node from a remote data store.

3. The UE of claim 2, wherein the high-priority L2 node has a usage counter with a value indicating that data measurements stored for the respective bucket corresponding to the high-priority L2 node are accessed frequently.

4. The UE of claim 2, wherein the one or more processors are further configured to:
perform, for the at least one L1 node having an index in the L1 list ranging from the pivot index to the first terminal index, the following:
determine that data measurements of the respective bucket corresponding to the high-priority L2 node are likely to be accessed because the data measurements in the respective bucket were taken during a range of time in which frequently-accessed data measurements were taken; and
identify the high-priority L2 node in the hash table associated with the at least one L1 node based on the determination that data measurements of the respective bucket corresponding to the high-priority L2 node are likely to be accessed.

5. The UE of claim 1, wherein the one or more processors are further configured to:
perform, for each respective L1 node having an index in the L1 list ranging from the pivot index to a second terminal index, the following:
identify one or more L2 nodes in a hash table associated with the respective L1 node, wherein the one or more L2 nodes correspond to buckets for which data measurements are stored in the local digital memory at the UE; and
delete the data measurements that are stored for the buckets corresponding to the one or more L2 nodes from the local digital memory.

6. The UE of claim 5, wherein the one or more processors are further configured to:
perform, for each respective L1 node having an index in the L1 list ranging from the pivot index to the second terminal index, the following:
identify one or more non-backed-up L2 nodes in a hash table associated with the respective L1 node, wherein the one or more L2 nodes correspond to buckets for which data measurements are stored in the local digital memory at the UE, and wherein each L2 node comprises an instance variable indicating whether the respective L2 node is backed up at a remote data store;
send the data measurements that are stored for the buckets corresponding to the one or more non-backed-up L2 nodes to the remote data store via a network connection; and
delete the data measurements that are stored for the buckets corresponding to the one or more non-backed-up L2 nodes from the local digital memory.

7. The UE of claim 1, wherein the one or more processors are further configured to:
perform, for each respective L1 node having an index in the L1 list ranging from the pivot index to the first terminal index, the following:
identify a number of high-priority L2 nodes in a hash table associated with the respective L1 node, wherein the number of high-priority L2 nodes is based on a respective element priority counter value of the respective L1 node;
determine that data measurements of a plurality of respective buckets corresponding to the plurality of high-priority L2 node are not stored in the local digital memory at the UE; and
issue a request to download the data measurements of the plurality of respective buckets corresponding to the plurality of high-priority L2 nodes from a remote data store.

8. A system for coordinating storage of data measurements, the system comprising:
one or more sensors configured to make data measurements;
a user equipment (UE) configured to receive data from the one or more sensors, the UE comprising local digital memory and circuitry configured to:
identify a level-1 (L1) list of level-1 (L1) nodes, wherein each respective L1 node comprises a respective element priority counter that is an instance variable indicating a frequency with which a respective hash table associated with the respective L1 node is accessed, wherein each hash table comprises level-2 (L2) nodes corresponding to buckets, wherein each L2 node comprises a respective usage counter that is an instance variable reflecting a frequency with which data measurements made by one or more sensors and stored for the respective bucket are accessed, and wherein the L1 nodes are sorted in the L1 list according to element priority counter values;
identify a pivot index for the L1 list;
perform, for each respective L1 node having an index in the L1 list ranging from the pivot index to a first terminal index, the following:
identify a high-priority L2 node in a hash table associated with the respective L1 node; and
determine whether data measurements of a respective bucket corresponding to the high-priority L2 node are stored in the local digital memory at the UE.

9. The system of claim 8, wherein the UE further comprises circuitry configured to:
perform, for at least one L1 node having an index in the L1 list ranging from the pivot index to the first terminal index, the following:
identify a high-priority L2 node in a hash table associated with the at least one L1 node;
determine that data measurements of a respective bucket corresponding to the high-priority L2 node are not stored in the local digital memory at the UE; and
issue a request to download the data measurements of the respective bucket corresponding to the high-priority L2 node from a remote data store.

10. The system of claim 9, wherein the high-priority L2 node has a usage counter with a value indicating that data measurements stored for the respective bucket corresponding to the high-priority L2 node are accessed frequently.

11. The system of claim 9, wherein the UE further comprises circuitry configured to:
perform, for the at least one L1 node having an index in the L1 list ranging from the pivot index to the first terminal index, the following:
determine that data measurements of the respective bucket corresponding to the high-priority L2 node are likely to be accessed because the data measurements in the respective bucket were taken during a range of time in which frequently-accessed data measurements were taken; and
identify the high-priority L2 node in the hash table associated with the at least one L1 node based on the determination that data measurements of the respective bucket corresponding to the high-priority L2 node are likely to be accessed.

12. The system of claim 8, wherein the UE further comprises circuitry configured to:
perform, for each respective L1 node having an index in the L1 list ranging from the pivot index to a second terminal index, the following:
identify one or more L2 nodes in a hash table associated with the respective L1 node, wherein the one or more L2 nodes correspond to buckets for which data measurements are stored in the local digital memory at the UE; and
delete the data measurements that are stored for the buckets corresponding to the one or more L2 nodes from the local digital memory.

13. The system of claim 12, wherein the UE further comprises circuitry configured to:
perform, for each respective L1 node having an index in the L1 list ranging from the pivot index to the second terminal index, the following:
identify one or more non-backed-up L2 nodes in a hash table associated with the respective L1 node, wherein the one or more L2 nodes correspond to buckets for which data measurements are stored in the local digital memory at the UE, and wherein each L2 node comprises an instance variable indicating whether the respective L2 node is backed up at a remote data store;
send the data measurements that are stored for the buckets corresponding to the one or more non-backed-up L2 nodes to the remote data store via a network connection; and
delete the data measurements that are stored for the buckets corresponding to the one or more non-backed-up L2 nodes from the local digital memory.

14. The system of claim 8, wherein the UE further comprises circuitry configured to:
perform, for each respective L1 node having an index in the L1 list ranging from the pivot index to the first terminal index, the following:
identify a number of high-priority L2 nodes in a hash table associated with the respective L1 node, wherein the number of high-priority L2 nodes is based on a respective element priority counter value of the respective L1 node;
determine that data measurements of a plurality of respective buckets corresponding to the plurality of high-priority L2 node are not stored in the local digital memory at the UE; and
issue a request to download the data measurements of the plurality of respective buckets corresponding to the plurality of high-priority L2 nodes from a remote data store.

15. A method of coordinating storage of data measurements between local digital memory at a user equipment (UE) and a remote data store, the method comprising:
identifying a level-1 (L1) list of level-1 (L1) nodes, wherein each respective L1 node comprises a respective element priority counter that is an instance variable indicating a frequency with which a respective hash table associated with the respective L1 node is accessed, wherein each hash table comprises level-2 (L2) nodes corresponding to buckets, wherein each L2 node comprises a respective usage counter that is an instance variable reflecting a frequency with which data measurements stored for the respective bucket are accessed, and wherein the L1 nodes are sorted in the L1 list according to element priority counter values;
identifying a pivot index for the L1 list;
performing, for each respective L1 node having an index in the L1 list ranging from the pivot index to a first terminal index, the following:
identifying a high-priority L2 node in a hash table associated with the respective L1 node; and
determining whether data measurements of a respective bucket corresponding to the high-priority L2 node are stored in the local digital memory at the UE.

16. The method of claim 15, further comprising:
performing, for at least one L1 node having an index in the L1 list ranging from the pivot index to the first terminal index, the following:
identifying a high-priority L2 node in a hash table associated with the at least one L1 node;
determining that data measurements of a respective bucket corresponding to the high-priority L2 node are not stored in the local digital memory at the UE; and
issuing a request to download the data measurements of the respective bucket corresponding to the high-priority L2 node from the remote data store.

17. The method of claim 16, wherein the high-priority L2 node has a usage counter with a value indicating that data measurements stored for the respective bucket corresponding to the high-priority L2 node are accessed frequently.

18. The method of claim 16, further comprising:
performing for the at least one L1 node having an index in the L1 list ranging from the pivot index to the first terminal index, the following:
determining that data measurements of the respective bucket corresponding to the high-priority L2 node are likely to be accessed because the data measurements in the respective bucket were taken during a range of time in which frequently-accessed data measurements were taken; and
identifying the high-priority L2 node in the hash table associated with the at least one L1 node based on the determination that data measurements of the respective bucket corresponding to the high-priority L2 node are likely to be accessed.

19. The method of claim 15, further comprising:
performing, for each respective L1 node having an index in the L1 list ranging from the pivot index to a second terminal index, the following:
identifying one or more L2 nodes in a hash table associated with the respective L1 node, wherein the one or more L2 nodes correspond to buckets for which data measurements are stored in the local digital memory at the UE; and
deleting the data measurements that are stored for the buckets corresponding to the one or more L2 nodes from the local digital memory.

20. The method of claim 19, further comprising:
performing, for each respective L1 node having an index in the L1 list ranging from the pivot index to the second terminal index, the following:
identifying one or more non-backed-up L2 nodes in a hash table associated with the respective L1 node, wherein the one or more L2 nodes correspond to buckets for which data measurements are stored in the local digital memory at the UE, and wherein each L2 node comprises an instance variable indicating whether the respective L2 node is backed up at the remote data store;
sending the data measurements that are stored for the buckets corresponding to the one or more non-backed-up L2 nodes to the remote data store via a network connection; and
deleting the data measurements that are stored for the buckets corresponding to the one or more non-backed-up L2 nodes from the local digital memory.

21. The method of claim 15, further comprising:
performing, for each respective L1 node having an index in the L1 list ranging from the pivot index to the first terminal index, the following:
identifying a number of high-priority L2 nodes in a hash table associated with the respective L1 node, wherein the number of high-priority L2 nodes is based on a respective element priority counter value of the respective L1 node;
determining that data measurements of a plurality of respective buckets corresponding to the plurality of high-priority L2 node are not stored in the local digital memory at the UE; and
issuing a request to download the data measurements of the plurality of respective buckets corresponding to the plurality of high-priority L2 nodes from the remote data store.
